(19) United States
(12) Patent Application Publication
(10) Pub. No.: US 2023/0168120 A1
(43) Pub. Date: Jun. 1, 2023

(54) Laser Interferometer

(71) Applicant: SEIKO EPSON CORPORATION, Tokyo (JP)

(72) Inventors: Nobuhito HAYASHI, Chino (JP); Kohei YAMADA, Shiojiri (JP)

(21) Appl. No.: 18/070,905

(22) Filed: Nov. 29, 2022

(30) Foreign Application Priority Data
Nov. 30, 2021 (JP) 2021-194022

(51) Int. Cl. G01H 9/00

(52) U.S. Cl. CPC G01H 9/00

(57) ABSTRACT

A laser interferometer includes: a laser light source configured to emit first laser light; an optical modulator that includes a resonator and that is configured to modulate the first laser light using the resonator and to generate second laser light including a modulation signal; a photodetector configured to receive the second laser light and third laser light including a sample signal generated by reflecting the first laser light from an object to be measured, and to output a light reception signal; an optical coupler that has a function of splitting the first laser light and a function of splitting combined light of the second laser light and the third laser light; a first collimator configured to collimate the first laser light split by the optical coupler; a second collimator configured to collimate the first laser light split by the optical coupler; a first optical wiring; a second optical wiring; a third optical wiring; and a fourth optical wiring.

The present application is based on, and claims priority from JP Application Serial Number 2021-194022, filed Nov. 30, 2021, the disclosure of which is hereby incorporated by reference herein in its entirety.

### BACKGROUND

### 1. Technical Field

The present disclosure relates to a laser interferometer.

### 2. Related Art

JP-A-2007-285898 discloses a laser vibrometer as a device that measures a vibration speed of an object. In this laser vibrometer, an object to be measured is irradiated with laser light, and a vibration speed is measured based on scattered laser light subjected to a Doppler shift.

Specifically, the laser vibrometer disclosed in JP-A-2007-285898 includes a resonator such as a piezo element. The resonator shifts a frequency of the laser light based on a vibration frequency. The object to be measured also shifts the frequency of the laser light according to a vibration state of the object. The light whose frequency is shifted by the resonator and the object to be measured returns to a half mirror as return light. The half mirror reflects the return light and causes the reflected return light to be incident on a photodetector, and the half mirror reflects a part of the laser light and then transmits the laser light after the laser light is reflected by a reflecting mirror, and the laser light is incident on the photodetector as reference light. Then, the return light and the reference light are photomixed by the photodetector, and a beat frequency is electrically extracted. Thereafter, a frequency modulated wave demodulator and a signal processing device detect vibration of the object to be measured as a frequency displacement and digitize the vibration.

The laser vibrometer disclosed in JP-A-2007-285898 includes optical elements such as a semiconductor laser that emits laser light, a half mirror, a polarization beam splitter, a λ/4 plate, a reflecting mirror, a resonator, and a photodetector. The polarization beam splitter transmits light emitted from the laser, reflects the light after the light is incident on the resonator, and causes the light to be incident on an object to be measured. The light is further reflected by the object to be measured and is incident on the resonator. As described above, the half mirror reflects the return light, transmits the reference light, and causes the return light and the reference light to be incident on the photodetector.

As described above, various optical elements are optically coupled to one another in the laser vibrometer disclosed in JP-A-2007-285898. Therefore, it is necessary to ensure a space for housing the optical elements, and it is difficult to reduce a size of an optical system. In order to extract a beat frequency with high accuracy, high accuracy is required for aligning the optical elements. Therefore, it takes time and effort to perform alignment. In addition, since an adjustment mechanism for performing alignment is required, it is difficult to reduce the size of the optical system from this point of view.

For the above reasons, it is expected to reduce the size of the optical system and simplify an alignment operation.

### SUMMARY

A laser interferometer according to an application example of the present disclosure includes: a laser light source configured to emit first laser light; an optical modulator that includes a resonator and that is configured to modulate the first laser light using the resonator and to generate second laser light including a modulation signal; a photodetector configured to receive the second laser light and third laser light including a sample signal generated by reflecting the first laser light from an object to be measured, and to output a light reception signal; an optical coupler on which the first laser light, the second laser light, and the third laser light are incident and that has a function of splitting the first laser light and a function of splitting combined light of the second laser light and the third laser light; a first collimator configured to collimate one light beam of the first laser light split by the optical coupler and to emit the collimated light toward the optical modulator; a second collimator configured to collimate the other light beam of the first laser light split by the optical coupler and to emit the collimated light toward the object to be measured; a first optical wiring that optically couples the laser light source and the optical coupler and that is configured to cause the first laser light emitted from the laser light source to be incident on the optical coupler; a second optical wiring that optically couples the photodetector and the optical coupler and that is configured to cause the combined light split by the optical coupler to be incident on the photodetector; a third optical wiring that optically couples the first collimator and the optical coupler; and a fourth optical wiring that optically couples the second collimator and the optical coupler.

### BRIEF DESCRIPTION OF THE DRAWINGS

FIG. 1 is a functional block diagram showing a laser interferometer according to a first embodiment.

FIG. 2 is a schematic configuration diagram showing a sensor head unit shown in FIG. 1.

FIG. 3 is a perspective view showing a first configuration example of an optical modulator shown in FIG. 2.

FIG. 4 is a plan view showing a part of a second configuration example of the optical modulator.

FIG. 5 is a plan view showing a third configuration example of the optical modulator.

FIG. 6 is a conceptual diagram showing that a plurality of diffracted light beams are generated when incident light Kᵢ is incident from a direction perpendicular to a front surface of a resonator.

FIG. 7 is a conceptual diagram showing the optical modulator configured such that an angle formed by a traveling direction of the incident light Kᵢ and a traveling direction of reference light L2 is 180°.

FIG. 8 is a conceptual diagram showing the optical modulator configured such that the angle formed by the traveling direction of the incident light Kᵢ and the traveling direction of the reference light L2 is 180°.

FIG. 9 is a conceptual diagram showing the optical modulator configured such that the angle formed by the traveling direction of the incident light Kᵢ and the traveling direction of the reference light L2 is 180°.

FIG. 10 is a cross sectional view showing the optical modulator having a package structure.

FIG. 11 is a circuit diagram showing a configuration of a single-stage inverter oscillation circuit.

FIG. 12 is an example of a circuit diagram showing an LCR equivalent circuit of a resonator.

FIG. 13 is a perspective view showing a sensor head unit provided in a laser interferometer according to a first modification of the first embodiment.

FIG. 14 is a schematic configuration diagram showing a sensor head unit provided in a laser interferometer according to a second modification of the first embodiment.

FIG. 15 is a schematic configuration diagram showing a sensor head unit provided in a laser interferometer according to a second embodiment.

FIG. 16 is a schematic configuration diagram showing a sensor head unit provided in a laser interferometer according to a third embodiment.

FIG. 17 is a schematic configuration diagram showing a sensor head unit provided in a laser interferometer according to a fourth embodiment.

FIG. 18 is a schematic configuration diagram showing a sensor head unit provided in a laser interferometer according to a fifth embodiment.

FIG. 19 is a schematic configuration diagram showing a sensor head unit provided in a laser interferometer according to a sixth embodiment.

### DESCRIPTION OF EXEMPLARY EMBODIMENTS

Hereinafter, a laser interferometer according to an aspect of the present disclosure will be described in detail based on embodiments shown in the accompanying drawings.

### 1. First Embodiment

First, a laser interferometer according to a first embodiment will be described.

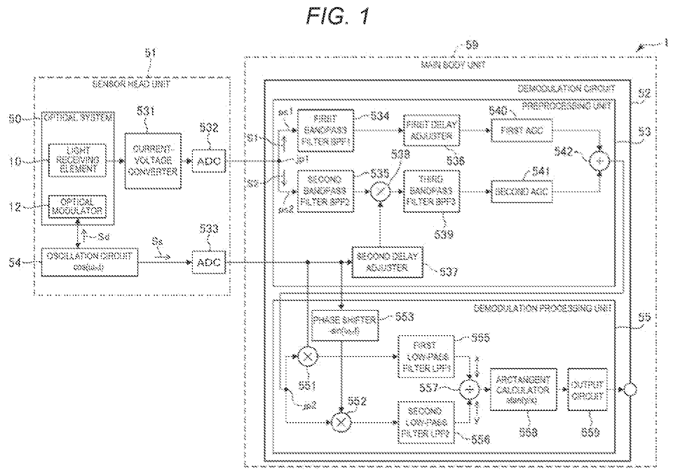

FIG. 1 is a functional block diagram showing a laser interferometer 1 according to the first embodiment.

The laser interferometer 1 shown in FIG. 1 includes a sensor head unit 51 and a main body 59. The sensor head unit 51 includes an optical system 50, a current-voltage converter 531, and an oscillation circuit 54. The main body 59 includes a demodulation circuit 52 to which a light reception signal from the optical system 50 is input.

### 1.1. Sensor Head Unit

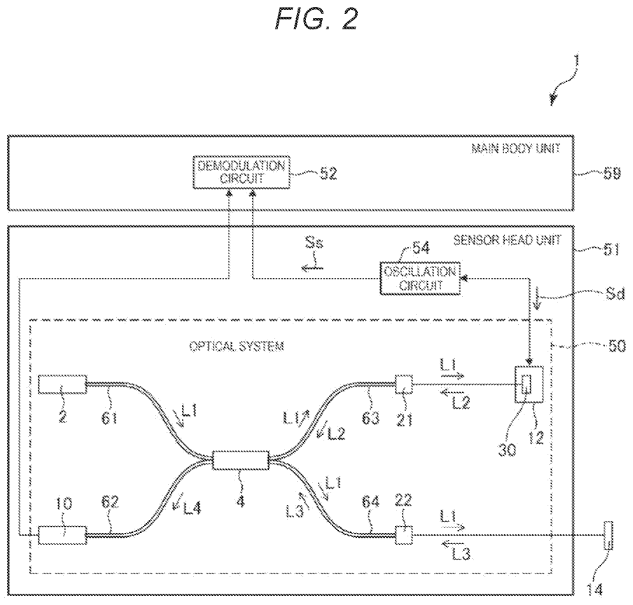

FIG. 2 is a schematic configuration diagram showing the sensor head unit 51 shown in FIG. 1.

### 1.1.1. Optical System

As shown in FIG. 2, the optical system 50 includes a laser light source 2, an optical coupler 4, a photodetector 10, a collimator 21 (a first collimator), an optical modulator 12 of a frequency shifter type, a collimator 22 (a second collimator), and an object to be measured 14.

An optical fiber 61 (a first optical wiring) is provided between the laser light source 2 and the optical coupler 4. The optical fiber 61 optically couples the laser light source 2 and the optical coupler 4.

An optical fiber 62 (a second optical wiring) is provided between the photodetector 10 and the optical coupler 4. The optical fiber 62 optically couples the photodetector 10 and the optical coupler 4.

An optical fiber 63 (a third optical wiring) is provided between the collimator 21 and the optical coupler 4. The optical fiber 63 optically couples the collimator 21 and the optical coupler 4.

An optical fiber 64 (a fourth optical wiring) is provided between the collimator 22 and the optical coupler 4. The optical fiber 64 optically couples the collimator 22 and the optical coupler 4.

As described above, in the optical system 50, optical elements such as the laser light source 2, the optical coupler 4, the photodetector 10, the collimator 21, the optical modulator 12, and the collimator 22 are optically coupled to one another via the optical fibers 61 to 64. In such an optical system 50, when the optical elements are coupled to one another, coupling locations where light propagates in a free space is reduced. Therefore, an alignment operation can be easily performed, and a situation in which the alignment operation needs to be performed again is less likely to occur. In a coupling location where an alignment operation is required, there is a limit to the miniaturization of optical elements in consideration of an adjustment width, but such restriction is not necessary in the optical system 50, and a position adjustment device or the like necessary for the alignment operation is not necessary. Further, since the optical fibers 61 to 64 have flexibility, light can propagate in a bent state.

The laser light source 2 emits emitted light L1 (laser light). The optical coupler 4 splits the emitted light L1 into two light beams. One light beam of the emitted light L1 split by the optical coupler 4 is emitted to the optical modulator 12 including the resonator 30, and is reflected as reference light L2 including a modulation signal which is a Doppler signal derived from the resonator 30. The other light beam of the emitted light L1 split by the optical coupler 4 is emitted to the object to be measured 14, and is reflected as object light L3 including a sample signal which is a Doppler signal derived from the object to be measured 14. The reference light L2 and the object light L3 are combined by the optical coupler 4 to obtain combined light L4, and the combined light L4 is split into two light beams. The photodetector 10 receives one light beam of the combined light L4 split by the optical coupler 4 and converts the received light beam into an electric signal.

The sensor head unit 51 is movable. The term “movable” refers to that the sensor head unit 51 has portability and has a size that achieves a high degree of installation freedom. A position and a posture of the movable sensor head unit 51 are adjusted such that the emitted light L1 is emitted to the object to be measured 14. Therefore, the sensor head unit 51 may be provided in a position adjustment device such as a gonio-stage as necessary.

On the other hand, the main body 59 does not need to be movable. Therefore, the main body 59 can be provided in, for example, a storage rack, or a table.

Hereinafter, each unit of the optical system 50 will be further described.

### 1.1.1.1. Laser Light Source

The laser light source 2 is a laser light source that emits the emitted light L1 having coherence. A light source having a line width of a band of MHz or less may be used as the laser light source 2. Specific examples of the laser light source 2 include a gas laser such as a He—Ne laser, and a semiconductor laser element such as a distributed feedback-laser diode (DFB-LD), a fiber bragg grating laser diode (FBG-LD), a vertical cavity surface emitting laser (VCSEL) diode, and a Fabry-Perot laser diode (FP-LD).

In particular, the laser light source 2 is preferably a semiconductor laser element. Accordingly, it is possible to reduce a size and a weight of the laser light source 2 in particular. Therefore, it is possible to reduce a size of the laser interferometer 1. In particular, since the sensor head unit 51 that accommodates the optical system 50 is reduced in size and weight in the laser interferometer 1, operability of the laser interferometer 1 such as the degree of installation freedom of the sensor head unit 51 is improved.

### 1.1.1.2. Optical Coupler

The optical coupler 4 is a 2×2 coupler having four light input and output ends. The optical coupler 4 has a function of splitting the emitted light L1 incident on the optical coupler 4, a function of combining the reference light L2 and the object light L3 incident on the optical coupler 4 to obtain the combined light L4, and a function of splitting the combined light L4.

Examples of the optical coupler 4 include an optical fiber type coupler and an optical waveguide type coupler.

It is preferable to use the optical fiber type coupler as the optical coupler 4. The optical fiber type coupler is formed by, for example, fusing optical fibers. Therefore, the optical fiber type coupler has a structure in which the optical coupler 4 and the optical fibers 61 to 64 (the first optical wiring to the fourth optical wiring) extending from the fusion portion are integrated. The optical coupler 4 is a fusion portion between the optical fibers. Therefore, it is possible to implement the optical system 50 having a low optical loss using the optical fiber type coupler. In addition, since an operation of coupling the optical coupler 4 and the optical fibers 61 to 64 and an alignment operation are not required, there is also an advantage in that assembly of the optical system 50 becomes easy. The optical coupler 4 and the optical fibers 61 to 64 may be separate structures.

Each of the optical fibers 61 to 64 may be a glass optical fiber or a plastic optical fiber.

On the other hand, the optical waveguide type coupler is implemented by, for example, an optical waveguide having a branch core portion. In addition, the optical waveguide type coupler can be easily integrated with an optical waveguide wiring extending from the branch core portion. Therefore, the optical waveguide type coupler may also be a structure in which the optical coupler 4 and the optical waveguide wiring are integrated. The optical coupler 4 is the branch core portion. The optical waveguide wiring is the first optical wiring to the fourth optical wiring. The optical waveguide wiring can be easily formed in any path in a sheet-shaped member. Therefore, even when the optical waveguide type coupler including the optical waveguide wiring is used, it is possible to easily achieve miniaturization, weight reduction, space saving, and the like of the optical system 50.

Examples of a constituent material of the optical waveguide type coupler include a ferroelectric, a compound semiconductor, glass, and plastic.

A splitting ratio in the optical coupler 4 is not particularly limited, and is preferably 20:80 or more and 80:20 or less, and more preferably 40:60 or more and 60:40 or less. Accordingly, since a light intensity after the splitting is not extremely biased, it is possible to prevent a decrease in a signal-to-noise ratio (S/N ratio) of a light reception signal.

The laser light source 2 and the optical fiber 61, the photodetector 10 and the optical fiber 62, the collimator 21 and the optical fiber 63, and the collimator 22 and the optical fiber 64 may be physically and optically coupled to each other using an inclusion such as an optical adhesive, or may be optically coupled to each other via a minute free space. In particular, in a method for coupling the elements using an inclusion, after an alignment operation for coupling locations is completed in a manufacturing stage of the optical system 50, the alignment operation is not necessary unless an optical element is repaired, replaced, or the like. Therefore, it is possible to improve maintainability of the optical system 50. In addition, the method for coupling the elements using an inclusion is excellent in durability against a disturbance such as vibration, impact, and a temperature change.

### 1.1.1.3. Photodetector

One light beam of the combined light L4 split by the optical coupler 4 is incident on the photodetector 10. The photodetector 10 receives the combined light L4 and outputs a light reception signal. A sample signal is demodulated from the light reception signal using a method to be described later, so that a movement of the object to be measured 14, that is, a vibration speed and a displacement can be finally obtained. Examples of the photodetector 10 include a photodiode.

### 1.1.1.4. Collimator

The collimator 21 is an optical element disposed between the optical fiber 63 and the optical modulator 12. An example of the collimator 21 includes an aspherical lens. The collimator 21 collimates the emitted light L1 that is split by the optical coupler 4 and that propagates through the optical fiber 63, and emits the collimated light toward the optical modulator 12. The emitted light L1 propagates through a free space and is incident on the optical modulator 12. The reference light L2 generated by the optical modulator 12 propagates through a free space and is incident on the optical fiber 63 via the collimator 21. In the present specification, the term “collimate” not only refers to converting divergent light into complete parallel light, but also refers to correcting the divergent light in a direction in which a beam divergence angle of the divergent light is reduced. Therefore, for example, the emitted light L1 or the reference light L2 that passed through the collimator 21 may not be completely parallel light.

In order to optically couple the collimator 21 and the optical modulator 12, an alignment operation is required. Examples of the alignment operation include an operation of adjusting a position of the collimator 21 to collimate the emitted light L1, an operation of causing the emitted light L1 to be incident on the optical modulator 12, and an operation of adjusting an installation angle of the optical modulator 12 to couple the reference light L2 to the collimator 21.

The collimator 22 is an optical element disposed between the optical fiber 64 and the object to be measured 14. An example of the collimator 22 includes an aspherical lens. The collimator 22 collimates the emitted light L1 that is split by the optical coupler 4 and that propagates through the optical fiber 64, and emits the collimated light toward the object to be measured 14. The emitted light L1 propagates through a free space and is incident on the object to be measured 14. The object light L3 generated by the object to be measured 14 propagates through a free space and is incident on the optical fiber 64 via the collimator 22.

In order to optically couple the collimator 22 and the object to be measured 14, an alignment operation is required. Examples of the alignment operation include an operation of adjusting a position of the collimator 22 to collimate the emitted light L1, an operation of causing the emitted light L1 to be incident on the object to be measured 14, and an operation of adjusting an installation angle of the sensor head unit 51 to couple the object light L3 to the collimator 22.

Each of the collimator 21 and the collimator 22 may include an optical element other than an aspherical lens.

### 1.1.1.5. Optical Modulator

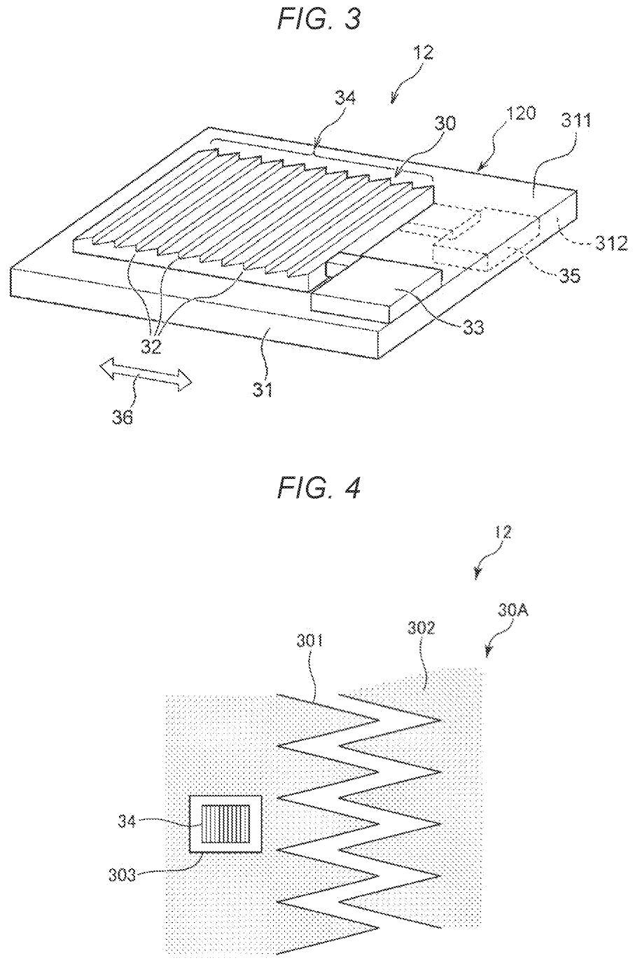

FIG. 3 is a perspective view showing a first configuration example of the optical modulator 12 shown in FIG. 2.

### 1.1.1.5.1. Overview of First Configuration Example of Optical Modulator

The optical modulator 12 of a frequency shifter type includes an optical modulation resonator 120. The optical modulation resonator 120 shown in FIG. 3 includes a plate-shaped resonator 30 and a substrate 31 that supports the resonator 30.

The resonator 30 is made of a material that repeats a mode in which the resonator 30 vibrates in a manner of being distorted in a direction along a surface by applying a voltage. In the present configuration example, the resonator 30 is a quartz crystal AT resonator that performs thickness shear vibration along a vibration direction 36 in a high frequency region of a band of MHz. A diffraction grating 34 is formed on a front surface of the resonator 30. The diffraction grating 34 has a plurality of grooves 32 having a component intersecting the vibration direction 36, that is, a plurality of linear grooves 32 extending in a direction intersecting the vibration direction 36.

The substrate 31 has a front surface 311 and a back surface 312 having a front and back relationship relative to each other. The resonator 30 is disposed on the front surface 311. A pad 33 for applying a voltage to the resonator 30 is provided on the front surface 311. In addition, a pad 35 for applying a voltage to the resonator 30 is provided on the back surface 312.

A long side of the substrate 31 is, for example, about 0.5 mm or more and 10.0 mm or less. A thickness of the substrate 31 is, for example, about 0.10 mm or more and 2.0 mm or less. For example, a shape of the substrate 31 is a square having a side of 1.6 mm and a thickness of 0.35 mm.

A long side of the resonator 30 is, for example, about 0.2 mm or more and 3.0 mm or less. A thickness of the resonator 30 is, for example, about 0.003 mm or more and 0.5 mm or less.

For example, a shape of the resonator 30 is a square having a side of 1.0 mm and a thickness of 0.07 mm. In this case, the resonator 30 oscillates at a basic oscillation frequency of 24 MHz. The oscillation frequency can be adjusted in a range of 1 MHz to 1 GHz by changing a thickness of the resonator 30 or considering an overtone.

Although the diffraction grating 34 is formed on the entire front surface of the resonator 30 in FIG. 3, the diffraction grating 34 may be formed only on a part of the front surface of the resonator 30.

A magnitude of an optical modulation performed by the optical modulator 12 is determined by an inner product of a vector of the resonator 30 in the vibration direction 36 and a difference wavenumber vector between a wavenumber vector of the emitted light L1 that is incident on the optical modulator 12 and a wavenumber vector of the reference light L2 emitted from the optical modulator 12. Although the resonator 30 performs a thickness shear vibration in the present configuration example, since this vibration is an in-plane vibration, even when light is incident perpendicularly to the front surface of the resonator 30 alone, an optical modulation cannot be performed. Therefore, the diffraction grating 34 is provided on the resonator 30 in the present configuration example, so that an optical modulation can be performed according to a principle to be described later.

The diffraction grating 34 shown in FIG. 3 is a blazed diffraction grating. The blazed diffraction grating refers to a diffraction grating having a stepwise cross sectional shape. The linear grooves 32 of the diffraction grating 34 are formed such that an extending direction of the linear grooves 32 is orthogonal to the vibration direction 36.

When a drive signal Sd is supplied (an AC voltage is applied) from the oscillation circuit 54 shown in FIGS. 1 and 2 to the resonator 30 shown in FIG. 3, the resonator 30 oscillates. Power (drive power) required for the oscillation of the resonator 30 is not particularly limited, and is as small as about 0.1 ρW to 100 mW. Therefore, the drive signal Sd output from the oscillation circuit 54 can be used to cause the resonator 30 to oscillate without amplifying the drive signal Sd.

Since an optical modulator in the related art may require a structure for maintaining a temperature of the optical modulator, it is difficult to reduce a volume of the optical modulator. Further, an optical modulator in the related art has a problem in that it is difficult to reduce a size and power consumption of a laser interferometer because of large power consumption. In contrast, since a volume of the resonator 30 is fairly small and power required for the oscillation of the resonator 30 is small, a size and power consumption of the laser interferometer 1 can be easily reduced in the present configuration example.

### 1.1.1.5.2. Method for Forming Diffraction Grating

A method for forming the diffraction grating 34 is not particularly limited, and examples of the method include a method in which a mold is formed using a mechanical wire type (a ruling engine) method, and in which the grooves 32 are formed on an electrode film-formed on a front surface of the resonator 30 using a nanoimprinting method. Here, a reason why the grooves 32 are formed on the electrode is that a high-quality thickness shear vibration can be caused on the electrode in principle in the case of a quartz crystal AT resonator. The grooves 32 are not limited to being formed on the electrode, and may be formed on a front surface of a material of a non-electrode portion. Further, instead of the nanoimprinting method, a processing method by exposure and etching, an electron beam lithography method, a focused ion beam (FIB) processing method, or the like may be used.

The diffraction grating may be formed of a resist material on a chip of a quartz crystal AT resonator, and a mirror film formed of a metal film or a dielectric multilayer film may be provided on the diffraction grating. Reflectance of the diffraction grating 34 can be increased by providing the metal film or the mirror film.

Further, a resist film may be formed on a chip or a wafer of a quartz crystal AT resonator, processed by etching, then the resist film is removed, and thereafter a metal film or a mirror film may be formed on a surface to be processed. In this case, since the resist material is removed, an influence of moisture absorption or the like of the resist material can be eliminated, and chemical stability of the diffraction grating 34 can be improved. Further, a metal film having high conductivity such as Au or Al is provided, so that the metal film can also be used as an electrode for driving the resonator 30.

The diffraction grating 34 may be formed using a technique such as anodized alumina (porous alumina).

### 1.1.1.5.3. Other Configuration Example of Optical Modulator

The resonator 30 is not limited to a quartz crystal resonator, and may be, for example, a Si resonator, a surface acoustic wave (SAW) device, and a ceramic resonator.

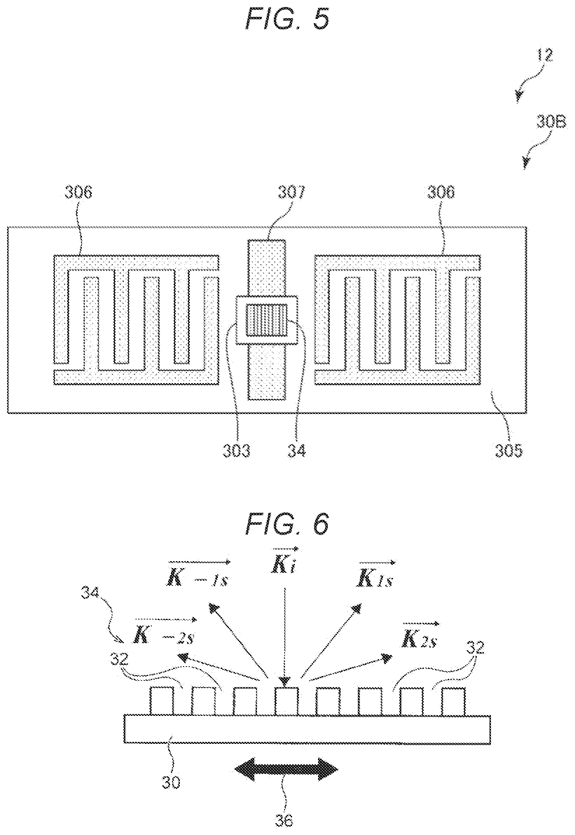

FIG. 4 is a plan view showing a part of a second configuration example of the optical modulator 12. FIG. 5 is a plan view showing a third configuration example of the optical modulator 12.

A resonator 30A shown in FIG. 4 is a Si resonator manufactured from a Si substrate using an MEMS technique. The MEMS refers to a micro electro mechanical system.

The resonator 30A includes a first electrode 301 and a second electrode 302 that are adjacent to each other on the same plane with a gap between the first electrode 301 and the second electrode 302, a diffraction grating mounting portion 303 provided on the first electrode 301, and the diffraction grating 34 provided on the diffraction grating mounting portion 303. For example, the first electrode 301 and the second electrode 302 vibrate using electrostatic attraction as a drive force in a manner of repeatedly coming close to and separating from each other in a left-right direction in FIG. 4, that is, along an axis that couples the first electrode 301 and the second electrode 302 shown in FIG. 4. Accordingly, an in-plane vibration can be applied to the diffraction grating 34. An oscillation frequency of the Si resonator is, for example, about 1 kHz to several hundreds of MHz.

A resonator 30B shown in FIG. 5 is an SAW device using surface waves. The SAW refers to surface acoustic waves.

The resonator 30B includes a piezoelectric substrate 305, an inter digital transducer 306 provided on the piezoelectric substrate 305, a ground electrode 307, the diffraction grating mounting portion 303, and the diffraction grating 34. When an AC voltage is applied to the inter digital transducer 306, surface acoustic waves are excited by an inverse piezoelectric effect. Accordingly, an in-plane vibration can be applied to the diffraction grating 34. An oscillation frequency of the SAW device is, for example, about several hundreds of MHz to several GHz.

In the device described above as well, it is also possible to perform an optical modulation according to a principle to be described later by providing the diffraction grating 34 in a similar manner to the case of a quartz crystal AT resonator.

On the other hand, when the resonator 30 is a quartz crystal resonator, a highly accurate modulation signal can be generated using a fairly high Q value of the quartz crystal. The Q value is an index indicating sharpness of a resonance peak. In addition, the quartz crystal resonator has a feature that the quartz crystal resonator is less likely to be affected by disturbance. Therefore, a sample signal derived from the object to be measured 14 can be acquired with high accuracy using a modulation signal modulated by the optical modulator 12 including a quartz crystal resonator.

### 1.1.1.5.4. Optical Modulation Performed by Resonator

Next, a principle of modulating light using the resonator 30 will be described.

FIG. 6 is a conceptual diagram showing that a plurality of diffracted light beams are generated when incident light Kᵢ is incident from a direction perpendicular to a front surface of the resonator 30.

As shown in FIG. 6, when the incident light Kᵢ is incident on the diffraction grating 34 that performs a thickness shear vibration along the vibration direction 36, a plurality of diffracted light beams Kₙₛ are generated due to a diffraction phenomenon. n is an order of the diffracted light Kₙₛ, and n=0, ±1, ±2, and the like. The diffraction grating 34 shown in FIG. 6 does not show the blazed diffraction grating shown in FIG. 3, but shows a diffraction grating formed by repeating irregularities as an example of another diffraction grating. Illustration of the diffracted light beam K₀ₛ is omitted in FIG. 6.

Although the incident light Kᵢ is incident from a direction perpendicular to the front surface of the resonator 30 in FIG. 6, an incident angle of the incident light Kᵢ is not particularly limited. Alternatively, the incident angle may be set such that the incident light Kᵢ is obliquely incident on the front surface of the resonator 30. When the incident light Kᵢ is obliquely incident, a traveling direction of the diffracted light Kₙₛ also changes accordingly.

Depending on a design of the diffraction grating 34, high-order light of |n|≥2 may not appear. Therefore, it is desirable to set |n|=1 in order to stably obtain a modulation signal. That is, in the laser interferometer 1 shown in FIG. 2, the optical modulator 12 of a frequency shifter type may be preferably disposed such that ±1 diffracted light beams are used as the reference light L2. With such an arrangement, a measurement performed by the laser interferometer 1 can be stabilized.

On the other hand, when high-order light of |n|≥2 appears from the diffraction grating 34, the optical modulator 12 may be disposed such that any diffracted light beam of ±2 or higher is used as the reference light L2 instead of the ±1 diffracted light beams. Accordingly, high-order diffracted light can be used, so that the laser interferometer 1 can be made higher in frequency and smaller in size.

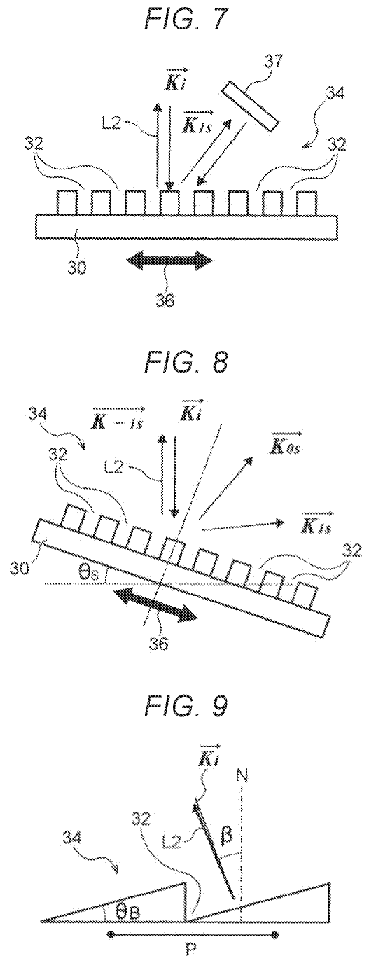

In the present embodiment, for example, the optical modulator 12 is configured such that an angle formed by an entering direction of the incident light Kᵢ incident on the optical modulator 12 and a traveling direction of the reference light L2 emitted from the optical modulator 12 is 180°. Hereinafter, three examples will be described with reference to FIGS. 7 to 9.

FIGS. 7 to 9 are conceptual diagrams showing the optical modulator 12 configured such that an angle formed by the entering direction of the incident light Kᵢ and the traveling direction of the reference light L2 is 180°.

In FIG. 7, a mirror 37 is provided in addition to the resonator 30. The mirror 37 is disposed in a manner of reflecting the diffracted light K₁ₛ and returning the diffracted light K₁ₛ to the diffraction grating 34. At this time, an angle formed by an incident angle of the diffracted light K₁ₛ relative to the mirror 37 and a reflection angle of the diffracted K₁ₛ reflected by the mirror 37 is 180°. As a result, the diffracted light K₁ₛ emitted from the mirror 37 and returned to the diffraction grating 34 is diffracted again by the diffraction grating 34 and travels in a direction opposite to the entering direction of the incident light Kᵢ that is incident on the optical modulator 12. Therefore, it is possible to satisfy the above-described condition that the angle formed by the entering direction of the incident light Kᵢ and the traveling direction of the reference light L2 is 180° by providing the mirror 37.

Since the diffracted light K₁ₛ is reflected by the mirror 37 in this manner, the reference light L2 generated by the optical modulator 12 is subjected to a frequency modulation twice. Therefore, it is possible to perform a frequency modulation at a higher frequency using the mirror 37 in combination as compared with a case of using the resonator 30 alone.

In FIG. 8, the resonator 30 is inclined as compared with an arrangement in FIG. 6. An inclination angle θs at this time is set in a manner of satisfying the above-described condition that an angle formed by the entering direction of the incident light Kᵢ and the traveling direction of the reference light L2 is 180°.

The diffraction grating 34 shown in FIG. 9 is a blazed diffraction grating having a blaze angle θ_{B}. When the incident light Kᵢ traveling at an incident angle β relative to a normal line N of the front surface of the resonator 30 is incident on the diffraction grating 34, the reference light L2 returns at the same angle as the blaze angle θ_{B} relative to the normal line N. Therefore, it is possible to satisfy the above-described condition that an angle formed by the entering direction of the incident light Kᵢ and the traveling direction of the reference light L2 is 180° by setting the incident angle β equal to the blaze angle θ_{B}. In this case, since the above-described condition can be satisfied without using the mirror 37 shown in FIG. 7 and without inclining the resonator 30 as shown in FIG. 8, it is possible to further reduce the size of the laser interferometer 1 and increase a frequency of the laser interferometer 1. In particular, in a case of a blazed diffraction grating, an arrangement satisfying the above condition is referred to as a “Littrow arrangement”, and there is an advantage in that a diffraction efficiency of diffracted light can be particularly increased.

A pitch P in FIG. 9 represents a pitch of a blazed diffraction grating, and for example, the pitch P is 1 μm. The blaze angle θ_{B} is, for example, 25°. In this case, the incident angle β relative to the normal line N of the incident light Kᵢ may also be set to 25° in order to satisfy the above-described condition.

### 1.1.1.5.5. Package Structure

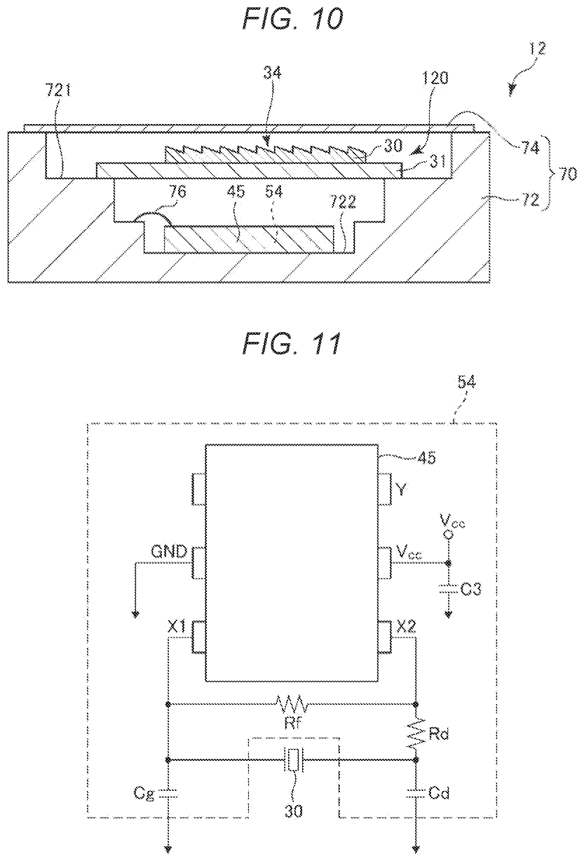

FIG. 10 is a cross sectional view showing the optical modulator 12 having a package structure.

The optical modulator 12 shown in FIG. 10 includes a container 70 serving as a housing, the optical modulation resonator 120 accommodated in the container 70, and a circuit element 45 provided in the oscillation circuit 54. The container 70 is hermetically sealed in, for example, a depressurized atmosphere such as vacuum or an inert gas atmosphere such as nitrogen or argon.

As shown in FIG. 10, the container 70 includes a container body 72 and a lid 74. The container body 72 includes a first recessed portion 721 provided inside the container body 72 and a second recessed portion 722 that is provided inside the first recessed portion 721 and that is deeper than the first recessed portion 721. The container body 72 is formed of a ceramic material, a resin material, or the like. Although not shown, the container body 72 includes an internal terminal provided at an inner surface, an external terminal provided at an outer surface, a wire that couples the internal terminal and the external terminal, and the like.

An opening of the container body 72 is closed by the lid 74 via a sealing member such as a seal ring or low melting point glass (not shown). Examples of constituent materials of the lid 74 include a material capable of transmitting laser light such as a glass material.

The optical modulation resonator 120 is disposed at a bottom surface of the first recessed portion 721. The optical modulation resonator 120 is supported at the bottom surface of the first recessed portion 721 by a bonding member (not shown). The internal terminal of the container body 72 and the optical modulation resonator 120 are electrically coupled to each other via a conductive material (not shown) such as a bonding wire or a bonding metal.

The circuit element 45 is disposed at a bottom surface of the second recessed portion 722. The circuit element 45 is electrically coupled to the internal terminal of the container body 72 via a bonding wire 76. Accordingly, the optical modulation resonator 120 and the circuit element 45 are also electrically coupled to each other via a wire provided in the container body 72. The circuit element 45 may be provided in a circuit other than the oscillation circuit 54 to be described later.

By adopting such a package structure, since the optical modulation resonator 120 and the circuit element 45 can overlap with each other, a physical distance between the optical modulation vibrator 120 and the circuit element 45 can be reduced, and a wire length between the optical modulation resonator 120 and the circuit element 45 can be reduced. Therefore, it is possible to prevent a noise from entering the drive signal Sd from the outside, or conversely, it is possible to prevent the drive signal Sd from becoming a noise source. In addition, both the optical modulation resonator 120 and the circuit element 45 can be protected from the external environment by one container 70. Therefore, it is possible to improve reliability of the laser interferometer 1 while reducing the size of the sensor head unit 51.

A structure of the container 70 is not limited to the structure shown in the drawings, and, for example, the optical modulation resonator 120 and the circuit element 45 may have separate package structures. Although not shown, other circuit elements provided in the oscillation circuit 54 may be accommodated in the container 70. The container 70 may be provided as needed, and may be omitted.

### 1.1.2. Current-Voltage Converter

The current voltage converter 531 is also called a transimpedance amplifier (TIA), and converts a photocurrent (a light reception signal) output from the photodetector 10 into a voltage signal and outputs the voltage signal as a light detection signal.

An ADC 532 shown in FIG. 1 is disposed between the current-voltage converter 531 and the demodulation circuit 52. The ADC 532 is an analog-to-digital converter, and converts an analog signal into a digital signal with a predetermined number of sampling bits. The ADC 532 is provided in the sensor head unit 51.

The optical system 50 may include a plurality of photodetectors 10. In this case, it is possible to perform differential amplification processing on the photocurrent and increase a signal-to-noise ratio (an S/N ratio) of a light detection signal, by providing a differential amplifier circuit between the plurality of photodetectors 10 and the current voltage converter 531. The differential amplification processing may be performed on the voltage signal.

### 1.1.3. Oscillation Circuit

As shown in FIG. 1, the oscillation circuit 54 outputs a drive signal Sd to be input to the optical modulator 12 of the optical system 50. In addition, the oscillation circuit 54 outputs a reference signal Ss to be input to the demodulation circuit 52.

The oscillation circuit 54 is not particularly limited as long as the oscillation circuit 54 is a circuit capable of oscillating the resonator 30, and circuits having various configurations can be used as the oscillation circuit 54. FIG. 11 is a circuit diagram showing a configuration of a one-stage inverter oscillation circuit as an example of a circuit configuration.

The oscillation circuit 54 shown in FIG. 11 includes the circuit element 45, a feedback resistor Rf, a limiting resistor Rd, a first capacitor Cg, a second capacitor Cd, and a third capacitor C3.

The circuit element 45 is an inverter IC. A terminal X1 and a terminal X2 of the circuit element 45 are terminals coupled to an inverter inside the circuit element 45. A terminal GND is coupled to a ground potential, and a terminal Vcc is coupled to a power supply potential. A terminal Y is a terminal for oscillation output.

The first capacitor Cg is coupled between the terminal X1 and the ground potential. The limiting resistor Rd and the second capacitor Cd that are coupled in series to each other are coupled between the terminal X2 and the ground potential in this order from the terminal X2 side. Further, one end of the feedback resistor Rf is coupled between the terminal X1 and the first capacitor Cg, and the other end of the feedback resistor Rf is coupled between the terminal X2 and the limiting resistor Rd.

One end of the resonator 30 is coupled between the first capacitor Cg and the feedback resistor Rf, and the other end of the resonator 30 is coupled between the second capacitor Cd and the limiting resistor Rd. Accordingly, the resonator 30 serves as a signal source of the oscillation circuit 54.

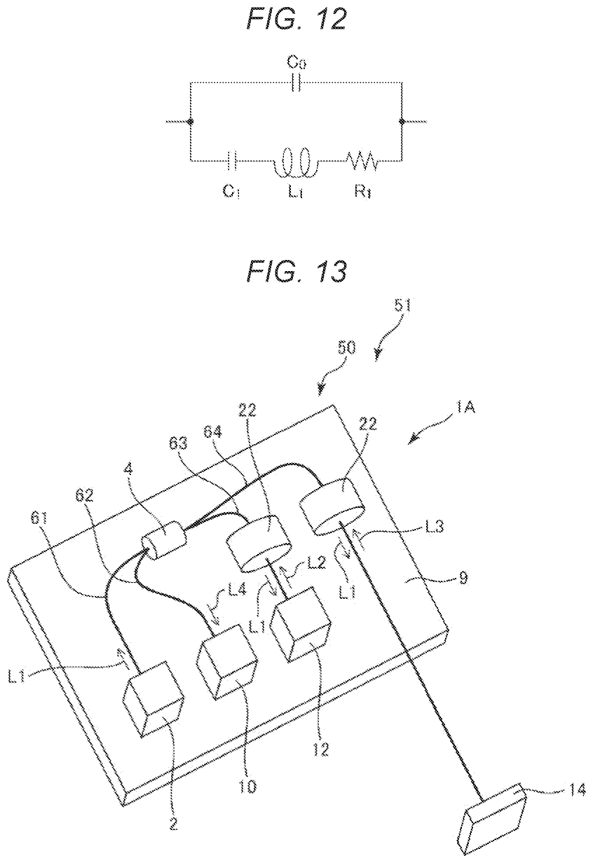

FIG. 12 is an example of a circuit diagram showing an LCR equivalent circuit of the resonator 30.

As shown in FIG. 12, the LCR equivalent circuit of the resonator 30 includes a series capacitance C₁, a series inductance L1, an equivalent series resistance R1, and a parallel capacitance C₀.

In the oscillation circuit 54 shown in FIG. 11, a load capacitance C_{L} is calculated according to the following Formula (a), in which a capacitance of the first capacitor Cg is defined as C_{g} and a capacitance of the second capacitor Cd is defined as C_{d}.

$${C}_{L} = \frac{{C}_{d} {C}_{g}}{{C}_{d} + {C}_{g}} \qquad ( a )$$

Then, an oscillation frequency f_{osc} output from the terminal Y of the oscillation circuit 54 is calculated according to the following Formula (b).

$${f}_{osc} = {f}_{Q} \sqrt{1 + \frac{{C}_{1}}{{C}_{0} + {C}_{L}}} \qquad ( b )$$

f_{Q} is the natural frequency of the resonator 30.

According to the Formula (b), it can be seen that the oscillation frequency f_{osc} of a signal output from the terminal Y can be finely adjusted by appropriately changing the load capacitance C_{L}.

A difference Δf between the natural frequency f_{Q} of the resonator 30 and the oscillation frequency f_{osc} of the oscillation circuit 54 is calculated according to the following Formula (c).

$$Δ f = {f}_{o s c} - {f}_{Q} = {f}_{Q} ( \sqrt{1 + \frac{{C}_{1}}{{C}_{0} + {C}_{L}}} - 1 ) \qquad ( c )$$

Here, since C₁<<C₀, and C₁<<C_{L}, Δf can be substantially calculated according to the following Formula (d).

$$Δ f = {f}_{osc} - {f}_{Q} ≅ \frac{{C}_{1}}{2 ( {C}_{0} + {C}_{L} )} {f}_{Q} \qquad ( d )$$

Therefore, the oscillation frequency f_{osc} of the oscillation circuit 54 has a value corresponding to the natural frequency f_{Q} of the resonator 30.

Here, for example, when the resonator 30 is fixed to the container 70, the natural frequency f_{Q} fluctuates when the resonator 30 receives an expansion stress caused by temperature via a fixing portion. In addition, when the resonator 30 is inclined, the natural frequency f_{Q} fluctuates under an influence of gravity or the like due to the own weight of the resonator 30.

In the oscillation circuit 54, when the natural frequency f_{Q} fluctuates for such a reason, the oscillation frequency f_{osc} changes in conjunction with the fluctuation based on the above-described Formula (d). That is, the oscillation frequency f_{osc} constantly has a value shifted from the natural frequency f_{Q} by Δf. Accordingly, the vibration of the resonator 30 is stabilized, and a displacement amplitude is stabilized. Since a modulation feature of the optical modulator 12 is stabilized by stabilizing the displacement amplitude, demodulation accuracy of a sample signal in the demodulation circuit 52 can be improved.

For example, it is preferable that Δf=|f_{osc}−f_{Q}| ≤3000 [Hz], and more preferable that Δf≤600 [Hz].

The laser interferometer 1 includes the demodulation circuit 52 and the oscillation circuit 54. Based on the reference signal Ss, the demodulation circuit 52 demodulates the sample signal that is derived from the object to be measured 14 from the light detection signal detected based on a photocurrent (the light reception signal). The oscillation circuit 54 operates using the resonator 30 as a signal source, and outputs the reference signal Ss to the demodulation circuit 52 as shown in FIG. 1.

According to such a configuration, even when the natural frequency f_{Q} of the resonator 30 fluctuates, the oscillation frequency f_{osc} of the oscillation circuit 54 can be changed to a value corresponding to the natural frequency f_{Q} of the resonator 30, so that the vibration of the resonator 30 can be easily stabilized. Accordingly, a temperature feature of a modulation signal can be made to correspond to a temperature feature of the resonator 30, and a modulation feature of the optical modulator 12 can be stabilized. As a result, demodulation accuracy of the sample signal in the demodulation circuit 52 can be improved.

In the above-described configuration, a temperature feature of the reference signal Ss output from the oscillation circuit 54 to the demodulation circuit 52 can also be made to correspond to the temperature feature of the resonator 30. In this case, since both the temperature feature of a modulation signal and the temperature feature of a reference signal correspond to the temperature feature of the resonator 30, a behavior of a fluctuation of the modulation signal and a behavior of a fluctuation of the reference signal Ss accompanying with a temperature change coincide with or are similar to each other. Therefore, even when a temperature of the resonator 30 changes, demodulation accuracy can be prevented from being affected, and demodulation accuracy of a sample signal derived from the object to be measured 14 can be improved.

Further, since power consumption of the oscillation circuit 54 is low, power saving of the laser interferometer 1 can be easily achieved.

As described above, the resonator 30 is preferably a quartz crystal resonator. Accordingly, a highly accurate modulation signal can be generated using an extremely high Q value of quartz crystal. As a result, a sample signal derived from the object to be measured 14 can be acquired with high accuracy.

For example, a signal generator such as a function generator or a signal generator may be used instead of the oscillation circuit 54.

### 1.2. Main Body

The main body 59 shown in FIGS. 1 and 2 includes the demodulation circuit 52.

The demodulation circuit 52 performs demodulation processing of demodulating a sample signal that is derived from the object to be measured 14 from a light detection signal output from the current voltage converter 531. The sample signal includes, for example, phase information and frequency information. A displacement of the object to be measured 14 can be acquired from the phase information, and a speed of the object to be measured 14 can be acquired from the frequency information. When different physical quantities can be acquired in this manner, the laser interferometer 1 can have functions of a displacement meter and a speedometer, so that it is possible to improve functionality of the laser interferometer 1.

A circuit configuration of the demodulation circuit 52 is set according to a method of modulation processing. In the laser interferometer 1 according to the present embodiment, the optical modulator 12 including the resonator 30 is used. Since the resonator 30 is an element that vibrates in a simple manner, a vibration speed changes every moment in a cycle. Therefore, a modulation frequency also changes with time, and a demodulation circuit in the related art cannot be used.

The demodulation circuit in the related art refers to, for example, a circuit that demodulates a sample signal from a light detection signal including a modulation signal modulated using an acousto-optic modulator (AOM). In the acousto-optic modulator, a modulation frequency does not change. Therefore, the demodulation circuit in the related art can demodulate a sample signal from a light detection signal including a modulation signal in which a modulation frequency does not change, but cannot demodulate a sample signal including a modulation signal modulated by the optical modulator 12 in which a modulation frequency changes.

Therefore, the demodulation circuit 52 shown in FIG. 1 includes a preprocessing unit 53 and a demodulation processing unit 55. A light detection signal output from the current voltage converter 531, first, passes through the preprocessing unit 53, and then is guided to the demodulation processing unit 55. The preprocessing unit 53 executes preprocessing on the light detection signal. A signal that can be demodulated by the demodulation circuit in the related art is obtained by the preprocessing. Therefore, the demodulation processing unit 55 demodulates a sample signal derived from the object to be measured 14 using a known demodulation method.

The above-described functions of the demodulation circuit 52 are implemented by, for example, hardware including a processor, a memory, an external interface, an input unit, a display unit, and the like. Specifically, the processor reads and executes a program stored in the memory, thereby implementing the functions. These components can communicate with one another via an internal bus.

Examples of the processor include a central processing unit (CPU), and a digital signal processor (DSP). Instead of the method in which the processor executes software, a method may be adopted in which a field-programmable gate array (FPGA), an application specific integrated circuit (ASIC), or the like executes software.

Examples of the memory include a hard disk drive (HDD), a solid state drive (SSD), an electrically erasable programmable read-only memory (EEPROM), a read-only memory (ROM), and a random access memory (RAM).

Examples of the external interface include a digital input and output port such as a universal serial bus (USB), an Ethernet (registered trademark) port, and the like.

Examples of the input unit include various input devices such as a keyboard, a mouse, a touch panel, and a touch pad. Examples of the display unit include a liquid quartz crystal display panel and an organic electro luminescence (EL) display panel.

### 1.2.1. Configuration of Preprocessing Unit

The preprocessing unit 53 shown in FIG. 1 includes a first bandpass filter 534, a second bandpass filter 535, a first delay adjuster 536, a second delay adjuster 537, a multiplier 538, a third bandpass filter 539, a first AGC 540, a second AGC 541, and an adder 542. The AGC refers to auto gain control.

A light detection signal output from the current voltage converter 531 is split into a first signal S1 and a second signal S2 at a branch portion jp1. In FIG. 1, a path of the first signal S1 is referred to as a first signal path ps1, and a path of the second signal S2 is referred to as a second signal path ps2.

An ADC 533 is coupled between the oscillation circuit 54 and the second delay adjuster 537. The ADC 533 is an analog-to-digital converter, and converts an analog signal into a digital signal with a predetermined number of sampling bits. The ADC 533 is provided in the sensor head unit 51.

The first bandpass filter 534, the second bandpass filter 535, and the third bandpass filter 539 are a filter that selectively transmits a signal in a specific frequency band.

The first delay adjuster 536 and the second delay adjuster 537 are a circuit that adjusts a delay of a signal. The multiplier 538 is a circuit that generates an output signal in proportion to a product of two input signals. The adder 542 is a circuit that generates an output signal in proportion to a sum of two input signals.

Next, an operation of the preprocessing unit 53 will be described along a flow of the first signal Si, the second signal S2, and the reference signal Ss.

A group delay of the first signal S1 is adjusted by the first delay adjuster 536 after the first signal S1 passes through the first bandpass filter 534 disposed on the first signal path ps1. The group delay adjusted by the first delay adjuster 536 corresponds to a group delay of the second signal S2 caused by the second bandpass filter 535 to be described later. Such a delay adjustment is performed such that delay times accompanying with signals passing through filter circuits between the first bandpass filter 534, and the second bandpass filter 535 and the third bandpass filter 539 can be made uniform. The first signal S1 passes through the first bandpass filter 534, and the second signal S2 passes through the second bandpass filter 535 and the third bandpass filter 539. The first signal S1 that passed through the first delay adjuster 536 is input to the adder 542 via the first AGC 540.

The second signal S2 is input to the multiplier 538 after the second signal S2 passes through the second bandpass filter 535 disposed on the second signal path ps2. The multiplier 538 multiplies the second signal S2 by the reference signal Ss output from the second delay adjuster 537. Specifically, the reference signal Ss that is represented by cos(ωₙt) and that is output from the oscillation circuit 54 is subjected to a digital conversion of the ADC 533 and a phase adjustment of the second delay adjuster 537, and is input to the multiplier 538. ωₘ is an angular frequency of a signal modulated by the optical modulator 12, and t is a time. Thereafter, the second signal S2 passes through the third bandpass filter 539, and then is input to the adder 542 via the second AGC 541.

The adder 542 outputs an output signal in proportion to a sum of the first signal S1 and the second signal S2. The circuit configuration of the preprocessing unit 53 described above is an example, and is not limited thereto.

### 1.2.2. Basic Principle of Preprocessing

Next, a basic principle of the preprocessing in the preprocessing unit 53 will be described. For example, a system will be considered in the following description in which a frequency changes in a sinusoidal shape as a modulation signal and a displacement of the object to be measured 14 changes with simple vibration in an optical axis. Here, Eₘ, E_{d}, and φ are expressed as follows.

Eₘ=aₘ{cos(ω₀t+B sin ωₘt+ϕₘ)+i sin(ω₀t+B sin ωₘt+ϕₘ)} (1)

E_{d}=a_{d}{cos(w₀t+A sin ω_{d}t+ϕ_{d})+i sin(ω₀t+A sin ω_{d}t+ϕ_{d})} (2)

ϕ=ϕₘ−ϕ_{d} (3)

A light detection signal I_{PD} output from the current-voltage converter 531 is theoretically expressed according to the following formula.

I_{PD}= [symbol] |Eₘ+E_{d}|²) [symbol] = [symbol] |Eₘ²+E_{d}²+2EₘE_{d}| [symbol] =aₘ²+a_{d}²+2aₘa_{d} cos(B sin ωₘt−A sin ω_{d}t+ϕ) (4)

Eₘ, E_{d}, φₘ, φ_{d}, φ, ωₘ, ω_{d}, ω₀, aₙ, and a_{d} are expressed as follows.

Eₘ: electric field component of modulation signal derived from optical modulator

E_{d}: electric field component of sample signal derived from object to be measured

φₘ: initial phase of modulation signal derived from optical modulator

φ_{d}: initial phase of sample signal derived from object to be measured

φ: optical path phase difference of laser interferometer

ωₘ: angular frequency of modulation signal derived from optical modulator

ω_{d}: angular frequency of sample signal derived from object to be measured

ω₀: angular frequency of light emitted from light source

aₙ: coefficient

a_{d}: coefficient

< > in the Formula (4) represents a time average.

A first term and a second term in the Formula (4) represent DC components, and a third term represents an AC component. When the AC component is defined as I_{PD}·_{AC}, I_{PD}·_{AC} satisfies the following Formula.

$$\begin{matrix}{I}_{PD \cdot AC} = 2 {a}_{m} {a}_{d} cos ( B sin {ω}_{m} t - A sin {ω}_{d} t + ϕ ) \\ = 2 {a}_{m} {a}_{d} \{ cos ( B sin {ω}_{m} t ) cos ( A sin {ω}_{d} t - ϕ ) + \\ sin ( B sin {ω}_{m} t ) sin ( A sin {ω}_{d} t - ϕ ) \}\end{matrix} \qquad ( 5 )$$

$$A = \frac{{f}_{dmax}}{{f}_{d}} \qquad ( 6 )$$

$$B = \frac{{f}_{mmax}}{{f}_{m}} \qquad ( 7 )$$

A: phase shift of sample signal
f_{dmax}: Doppler frequency shift of sample signal
f_{d}: frequency of sample signal

B: phase shift of modulation signal
fₘₘₐₓ: Doppler frequency shift of modulation signal
fₘ: frequency of modulation signal

Here, ν-order Bessel functions such as the following Formulas (8) and (9) are known.

cos{ζ sin(2πfᵥt)}=J₀(ζ)+2J₂(ζ)cos(2·2πfᵥt)+2J₄(ζ)cos(4·2πfᵥt)+ (8)

sin{ζ sin(2πfᵥt)}=2J₁(ζ)sin(1·2πfᵥt)+2J₃(ζ)sin(3·2πfᵥt)+ (9)

When the above-described Formula (5) is subjected to series expansion using the Bessel functions of the Formulas (8) and (9), the Formula (5) can be transformed into the following Formula (10).

I_{PD.AC}=2aₘa_{d}[{J₀(B)+2J₂(B)cos(2·ωₘt)+2J₄(B)cos(4·ωₘt)+ . . . }cos(A sin ω_{d}t−ϕ) −{2J₁(B)sin(1·ωₘt)+2J₃(B)sin(3·ωₘt)+ . . . }sin(A sin ω_{d}t−ϕ)] (10)

J₀(B), J₁(B), J₂(B) . . . are Bessel coefficients.

When such a transformation is made, theoretically, it can be said that a band corresponding to a specific order can be extracted by a bandpass filter.

Therefore, the preprocessing unit 53 executes preprocessing on the light detection signal in the following flow based on this theory.

First, the light detection signal output from the current-voltage converter 531 is split into the first signal S1 and the second signal S2 at the branch portion jp1. The first signal S1 passes through the first bandpass filter 534. A center angular frequency of the first bandpass filter 534 is set to ωₘ. Accordingly, the first signal S1 that passed through the first bandpass filter 534 is expressed according to the following Formula.

Iₚₐₛₛ₁=J₁(B){−cos(ωₘt+A sin ω_{d}t−ϕ)+cos(ωₘt−A sin ω_{d}t+ϕ)}=−2J₁(B)sin(ωₘt)sin(A sin ω_{d}t−ϕ) (11)

On the other hand, the second signal S2 passes through the second bandpass filter 535. A center angular frequency of the second bandpass filter 535 is set to a value different from the center angular frequency of the first bandpass filter 534. Here, for example, the center angular frequency of the second bandpass filter 535 is set to 2ωₙ. Accordingly, the second signal S2 that passed through the second bandpass filter 535 is expressed according to the following Formula.

$$\begin{matrix}{I}_{BPF 2} = {J}_{2} ( B ) cos ( 2 \cdot {ω}_{m} t ) \cdot cos ( A sin {ω}_{d} t - ϕ ) \\ = \frac{1}{2} {J}_{2} ( B ) \{ cos ( 2 \cdot {ω}_{m} t + cos ( A sin {ω}_{d} t - ϕ ) ) + \\ cos ( 2 \cdot {ω}_{m} t - cos ( A sin {ω}_{d} t - ϕ ) ) \}\end{matrix} \qquad ( 12 )$$

The multiplier 538 multiplies the second signal S2 that passed through the second bandpass filter 535 by the reference signal Ss. The second signal S2 that passed through the multiplier 538 is expressed according to the following formula.

$$\begin{matrix}{I}_{cos ( {ω}_{m} t )} = \frac{1}{2} {J}_{2} ( B ) \{ cos ( 2 \cdot {ω}_{m} t + A sin {ω}_{d} t - ϕ ) + \\ cos ( 2 \cdot {ω}_{m} t - A sin {ω}_{d} t + ϕ ) \} \cdot cos ( {ω}_{m} t ) \\ = \frac{1}{2} {J}_{2} ( B ) \{ cos ( 3 \cdot {ω}_{m} t + A sin {ω}_{d} t - ϕ ) + \\ cos ( 1 \cdot {ω}_{m} t + A sin {ω}_{d} t - ϕ ) + \\ cos ( 3 \cdot {ω}_{m} t - A sin {ω}_{d} t + ϕ ) + cos ( 1 \cdot {ω}_{m} t - A sin {ω}_{d} t + ϕ ) \}\end{matrix} \qquad ( 13 )$$

The second signal S2 that passed through the multiplier 538 passes through the third bandpass filter 539. A central angular frequency of the third bandpass filter 539 is set to the same value as the central angular frequency of the first bandpass filter 534. Here, for example, the central angular frequency of the third bandpass filter 539 is set to ωₙ. Accordingly, the second signal S2 that passed through the third bandpass filter 539 is expressed according to the following Formula.

$$\begin{matrix}{I}_{pass 2} = \frac{1}{2} {J}_{2} ( B ) \{ cos ( {ω}_{m} t + A sin {ω}_{d} t - ϕ ) + cos ( {ω}_{m} t - A sin {ω}_{d} t + ϕ ) \} \\ = {J}_{2} ( B ) cos ( {ω}_{m} t ) cos ( A sin {ω}_{d} t - ϕ )\end{matrix} \qquad ( 14 )$$

Thereafter, the first delay adjuster 536 adjusts a phase of the first signal S1 expressed according to the above Formula (11), and the first AGC 540 adjusts an amplitude of the first signal S1.

The second AGC 541 adjusts an amplitude of the second signal S2 expressed according to the above Formula (14), and the amplitude of the second signal S2 is made equal to the amplitude of the first signal S1.

Then, the first signal S1 and the second signal S2 are added by the adder 542. An addition result is expressed according to the following Formula (15).

I₅₃=cos(ωₘt+A sin ω_{d}t−ϕ) (15)

As shown in the above Formula (15), as a result of the addition, an unnecessary term disappears, and a necessary term can be extracted. That is, an addition result I₅₃ expressed by Formula (15) is a signal obtained by extracting a frequency modulation component. The addition result I₅₃ is input to the demodulation processing unit 55.

### 1.2.3. Configuration of Demodulation Processing Unit

The demodulation processing unit 55 executes demodulation processing of demodulating a sample signal that is derived from the object to be measured 14 from a signal output from the preprocessing unit 53. The demodulation processing is not particularly limited, and a known quadrature detection method may be used. The quadrature detection method is a method for executing the demodulation processing by performing an operation of mixing external signals orthogonal to each other with an input signal.

The demodulation processing unit 55 shown in FIG. 1 is a digital circuit including a multiplier 551, a multiplier 552, a phase shifter 553, a first low-pass filter 555, a second low-pass filter 556, a divider 557, an arctangent calculator 558, and an output circuit 559.

The multipliers 551 and 552 are a circuit that generates an output signal in proportion to a product of two input signals. The phase shifter 553 is a circuit that generates an output signal in which an amplitude is not changed and a phase of the input signal is inverted. The first low-pass filter 555 and the second low-pass filter 556 are a filter that cuts off a signal in a high frequency band.

The divider 557 is a circuit that generates an output signal in proportion to a quotient of two input signals. The arctangent calculator 558 is a circuit that outputs an arctangent of an input signal. The output circuit 559 calculates a phase φ_{d} as information derived from the object to be measured 14 from a phase φ acquired by the arctangent calculator 558. The output circuit 559 performs phase coupling when there is a phase jump of 2n between two adjacent points by performing phase unwrapping processing. A displacement of the object to be measured 14 is calculated based on the obtained phase information. Accordingly, a function serving as a displacement meter is achieved. In addition, a speed of the object to be measured 14 can be calculated based on the displacement. Accordingly, a function serving as a speedometer is achieved.

The circuit configuration of the demodulation processing unit 55 described above is an example, and is not limited thereto. For example, the demodulation processing unit 55 is not limited to a digital circuit, and may be an analog circuit. The analog circuit may include an F/V converter circuit or a ΔΣ counter circuit.

### 1.2.4. Demodulation Processing Performed by Demodulation Processing Unit

In demodulation processing, first, a signal output from the preprocessing unit 53 is split into two signals at a branch portion jp2. The multiplier 551 multiplies one of the split signals by the reference signal Ss that is represented by cos(ωₘt) and is output from the oscillation circuit 54. The multiplier 552 multiplies the other split signal by a signal that is represented by −sin(ωₘt) and is obtained by the phase shifter 553 shifting a phase of the reference signal Ss output from the oscillation circuit 54 by −90°. The reference signal Ss and the signal obtained by shifting the phase of the reference signal Ss are signals whose phases are shifted from each other by 90°.

The signal that passed through the multiplier 551 passes through the first low-pass filter 555, and then is input to the divider 557 as a signal x. The signal that passed through the multiplier 552 passes through the second low-pass filter 556, and then is input to the divider 557 as a signal y. The divider 557 divides the signal y by the signal x, and an output y/x passes through the arctangent calculator 558 to obtain an output atan(y/x).

Thereafter, the output atan(y/x) passes through the output circuit 559 to calculate a phase φ_{d} as information derived from the object to be measured 14. The output circuit 559 performs a phase coupling when there is a phase jump of 2π between adjacent points by performing phase unwrapping processing. Then, a displacement of the object to be measured 14 can be calculated based on the phase information. Accordingly, a function serving as a displacement meter is achieved. Further, a speed can be calculated based on the displacement. Accordingly, a function serving as a speedometer is achieved.

On the other hand, the output circuit 559 may obtain frequency information. A speed of the object to be measured 14 can be calculated based on the frequency information.

1.3. Effects according to First Embodiment

As described above, the laser interferometer 1 according to the first embodiment includes the laser light source 2, the optical modulator 12, the photodetector 10, the optical coupler 4, the collimator 21 (the first collimator), the collimator 22 (the second collimator), the optical fiber 61 (the first optical wiring), the optical fiber 62 (the second optical wiring), the optical fiber 63 (the third optical wiring), and the optical fiber 64 (the fourth optical wiring).

The laser light source 2 emits the emitted light L1 (the first laser light). The optical modulator 12 includes the resonator 30, modulates the emitted light L1 using the resonator 30, and generates the reference light L2 (the second laser light) including a modulation signal. The photodetector 10 receives the reference light L2 and the object light L3 (the third laser light) including a sample signal generated by the object to be measured 14 reflecting the emitted light L1, and outputs a light reception signal. The emitted light L1, the reference light L2, and the object light L3 are incident on the optical coupler 4, and the optical coupler 4 has a function of splitting the emitted light L1, and has a function of splitting the combined light L4 obtained by combining the reference light L2 and the object light L3. The collimator 21 (the first collimator) collimates one light beam of the emitted light L1 split by the optical coupler 4, and emits the collimated light toward the optical modulator 12. The collimator 22 (the second collimator) collimates the other light beam of the emitted light L1 split by the optical coupler 4, and emits the collimated light toward the object to be measured 14.

The optical fiber 61 optically couples the laser light source 2 and the optical coupler 4, and causes the emitted light L1 emitted from the laser light source 2 to be incident on the optical coupler 4. The optical fiber 62 optically couples the photodetector 10 and the optical coupler 4, and causes the combined light L4 split by the optical coupler 4 to be incident on the photodetector 10. The optical fiber 63 optically couples the collimator 21 and the optical coupler 4. The optical fiber 64 optically couples the collimator 22 and the optical coupler 4.

According to such a configuration, when the optical elements such as the laser light source 2, the optical coupler 4, the photodetector 10, the collimator 21, the optical modulator 12, and the collimator 22 are coupled to one another, the optical fibers 61 to 64 that are optical wirings are used, and thus coupling locations where light propagates in a free space can be reduced. Therefore, an alignment operation of the optical system 50 can be easily performed, and a situation in which the alignment operation needs to be performed again is less likely to occur. In a coupling location where an alignment operation is required, there is a limit to the miniaturization of optical elements in consideration of an adjustment width, but such restriction is not necessary in the optical system 50, and a position adjustment device or the like necessary for the alignment operation is not necessary. Therefore, it is possible to easily reduce the size and the weight of the optical system 50. Further, since the optical fibers 61 to 64 have flexibility, light can propagate in a bent state. Therefore, an arrangement of the optical elements can be optimized, and space saving of the optical system 50 can be easily achieved.

In the present embodiment, the optical coupler 4 is an optical fiber type coupler. The first optical wiring, the second optical wiring, the third optical wiring, and the fourth optical wiring are the optical fibers 61 to 64 as described above.

According to such a configuration, since the optical fiber type coupler is formed by fusing optical fibers, a structure is implemented in which the optical coupler 4 and the optical fibers 61 to 64 are integrated. Accordingly, it is possible to implement the optical system 50 having a small optical loss.

The laser interferometer 1 according to the present embodiment includes the movable sensor head unit 51 and the main body 59. The laser light source 2, the optical modulator 12, the photodetector 10, the optical coupler 4, the collimator 21 (the first collimator), and the collimator 22 (the second collimator) are provided in the sensor head unit 51. The expression “provided in the sensor head unit 51” refers to that these optical elements are accommodated in a housing (not shown) of the sensor head unit 51 or attached to an outer side of the housing.

According to such a configuration, only an electric wiring (not shown) that electrically couples the sensor head unit 51 and the main body 59 is exposed to an external space, and on the other hand, all of the optical fibers 61 to 64 are provided in the sensor head unit 51. Therefore, the optical fibers 61 to 64 are prevented from being exposed to the external space, and an influence of a disturbance on optical signals transmitting through the optical fibers 61 to 64 can be prevented. Examples of the influence of the disturbance include an unintended change in the optical signals due to vibration, expansion and contraction, a temperature change, or the like of the optical fibers 61 to 64. Since the influence of such disturbances is prevented, it is possible to increase the S/N ratio of the light reception signal output from the photodetector 10. As a result, it is possible to improve measurement accuracy of a displacement and a speed of the object to be measured 14 that can be measured using the laser interferometer 1.

The laser interferometer 1 according to the present embodiment includes the demodulation circuit 52 and the oscillation circuit 54. The oscillation circuit 54 operates using the resonator 30 as a signal source, and outputs the reference signal Ss to the demodulation circuit 52 as shown in FIG. 1. The demodulation circuit 52 demodulates a sample signal that is derived from the object to be measured 14 from the light reception signal based on the reference signal Ss.

According to such a configuration, even when the natural frequency f_{Q} of the resonator 30 fluctuates, the oscillation frequency f_{osc} of the oscillation circuit 54 can be changed to a value corresponding to the natural frequency f_{Q} of the resonator 30, so that the vibration of the resonator 30 can be easily stabilized. Accordingly, a temperature feature of a modulation signal can be made to correspond to a temperature feature of the resonator 30, and a modulation feature of the optical modulator 12 can be stabilized. As a result, demodulation accuracy of the sample signal in the demodulation circuit 52 can be improved.

In the above-described configuration, a temperature feature of the reference signal Ss output from the oscillation circuit 54 to the demodulation circuit 52 can also be made to correspond to the temperature feature of the resonator 30. In this case, since both the temperature feature of a modulation signal and the temperature feature of a reference signal correspond to the temperature feature of the resonator 30, a behavior of a fluctuation of the modulation signal and a behavior of a fluctuation of the reference signal Ss accompanying with a temperature change coincide with or are similar to each other. Therefore, even when a temperature of the resonator 30 changes, demodulation accuracy can be prevented from being affected, and demodulation accuracy of a sample signal derived from the object to be measured 14 can be improved.

Since the power consumption of the oscillation circuit 54 is lower than that of a function generator, a signal generator, or the like, power saving of the laser interferometer 1 can be easily achieved.

### 1.4. First Modification of First Embodiment

Next, a first modification of the first embodiment will be described.

FIG. 13 is a perspective view showing the sensor head unit 51 provided in a laser interferometer 1A according to the first modification of the first embodiment.

Hereinafter, the first modification will be described. In the following description, differences from the first embodiment will be mainly described, and description of the same matters will be omitted. In FIG. 13, the same components as those according to the first embodiment are denoted by the same reference numerals.

The laser interferometer 1A according to the first modification further includes a mounting substrate 9 provided in the sensor head unit 51. As shown in FIG. 13, the laser light source 2, the optical modulator 12, the photodetector 10, the optical coupler 4, the collimator 21 (the first collimator), and the collimator 22 (the second collimator) are mounted on the mounting substrate 9.

According to such a configuration, since the optical elements described above can be fixed to the mounting substrate 9, it is possible to further reduce the size of the sensor head unit 51 and improve handleability. In addition, such a configuration also contributes to improvement of durability against a disturbance such as vibration, impact, and a temperature change.

Examples of the mounting substrate 9 include a resin substrate, a ceramic substrate, and a metal substrate. The mounting substrate 9 may be a circuit board. The circuit board refers to a board incorporated with an electric wiring. Accordingly, a part of the electrical wirings for electrically coupling the laser light source 2, the photodetector 10, and the optical modulator 12 to the main body 59 can be incorporated in the circuit board. Accordingly, it possible to further reduce the size of the sensor head unit 51 and facilitate the manufacture of the sensor head unit 51.

Similar to the first embodiment described above, the degree of freedom in an arrangement of the laser light source 2, the photodetector 10, and the optical modulator 12 is also high in the first modification. Therefore, it is possible to optimize the arrangement by taking into account an influence of electromagnetic noise generated from each unit.

It is preferable that two or more optical couplers 4 are fixed to the mounting substrate 9. Accordingly, even when vibration or impact is applied to the sensor head unit 51, the influence of the vibration or impact on the optical coupler 4 can be prevented.

The collimators 21 and 22 may be fixed on a front surface of the mounting substrate 9, or may be fixed by being fitted into a recessed portion or a through hole formed in the mounting substrate 9.

In the first modification as described above, the same effects as those according to the first embodiment can also be attained.

### 1.5. Second Modification of First Embodiment

Next, a second modification of the first embodiment will be described.

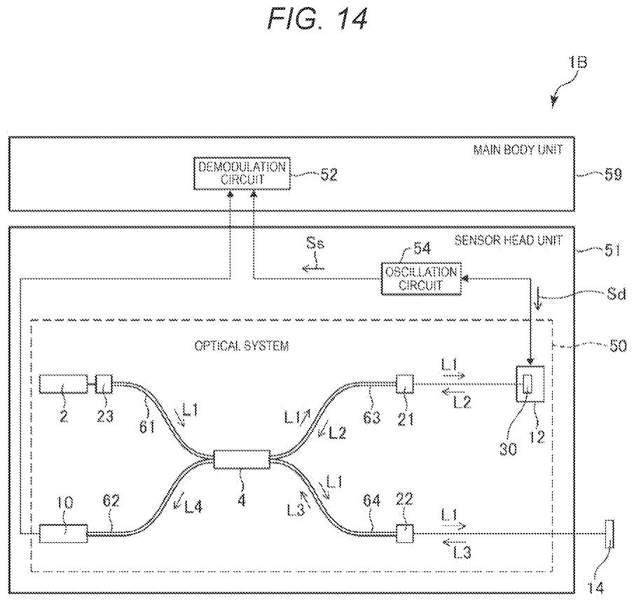

FIG. 14 is a schematic configuration diagram showing the sensor head unit 51 provided in a laser interferometer 1B according to the second modification of the first embodiment.

Hereinafter, the second modification will be described. In the following description, differences from the first embodiment will be mainly described, and description of the same matters will be omitted. In FIG. 14, the same components as those according to the first embodiment are denoted by the same reference numerals.

As shown in FIG. 14, the laser interferometer 1B according to the second modification is similar to the laser interferometer 1 according to the first embodiment except that the laser interferometer 1B includes a collimator 23 (a third collimator).

The collimator 23 (the third collimator) shown in FIG. 14 is provided between the laser light source 2 and the optical coupler 4, and collimates the emitted light L1 (the first laser light). The collimator 23 is an optical element disposed between the laser light source 2 and the optical coupler 4. An example of the collimator 23 is an aspherical lens. The emitted light L1 emitted from the laser light source 2 is incident on the optical fiber 61 via the collimator 23.

By providing such a collimator 23, it is possible to increase incidence efficiency of the emitted light L1 onto the optical fiber 61. That is, a coupling loss between the laser light source 2 and the optical fiber 61 can be reduced.

The collimator 23 may include an optical element other than the aspherical lens.

In the second modification as described above, the same effects as those according to the first embodiment can also be attained.

### 2. Second Embodiment

Next, a laser interferometer according to a second embodiment will be described.

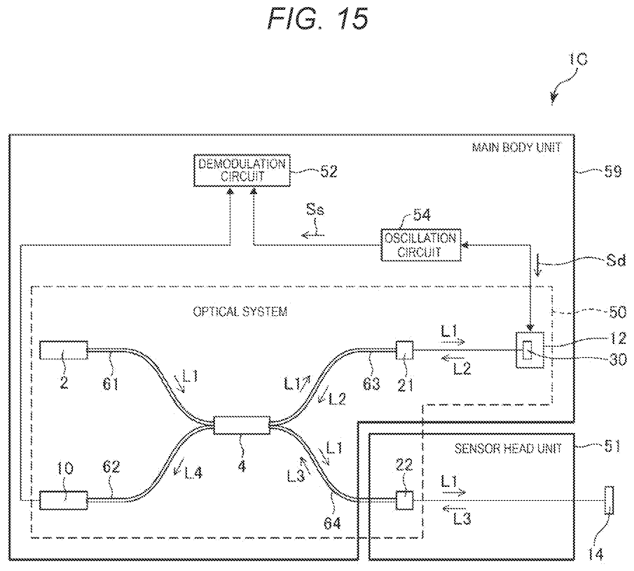

FIG. 15 is a schematic configuration diagram showing the sensor head unit 51 provided in a laser interferometer 1C according to the second embodiment.

Hereinafter, the second embodiment will be described. In the following description, differences from the first embodiment will be mainly described, and description of the same matters will be omitted. In FIG. 15, the same components as those according to the first embodiment are denoted by the same reference numerals.

In the first embodiment described above, the laser light source 2, the optical modulator 12, the photodetector 10, the optical coupler 4, the collimator 21 (the first collimator), and the collimator 22 (the second collimator) are all provided in the sensor head unit 51.

On the other hand, the laser interferometer 1C according to the present embodiment includes the movable sensor head unit 51 and the main body 59, and the collimator 22 (the second collimator) is provided in the sensor head unit 51, as shown in FIG. 15. On the other hand, the laser light source 2, the optical modulator 12, the photodetector 10, the optical coupler 4, and the collimator 21 (the first collimator) are provided in the main body 59. The expression “provided in the main body 59” refers to that these optical elements are accommodated in a housing (not shown) provided in the main body 59 or attached to an outer side of the housing.

According to such a configuration, it is possible to reduce optical elements provided in the sensor head unit 51 as compared with the first embodiment. Accordingly, it is possible to reduce the size of the sensor head unit 51 in particular.

In the second embodiment as described above, the same effects as those according to the first embodiment can also be attained.

### 3. Third Embodiment

Next, a laser interferometer according to a third embodiment will be described.

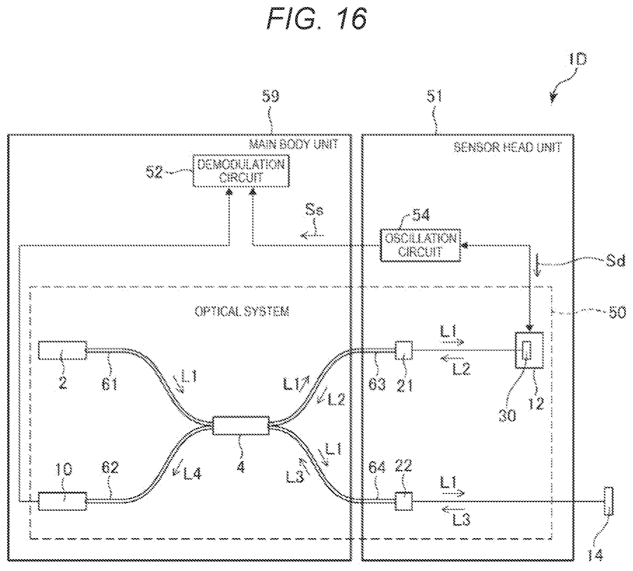

FIG. 16 is a schematic configuration diagram showing the sensor head unit 51 provided in a laser interferometer 1D according to the third embodiment.

Hereinafter, the third embodiment will be described. In the following description, differences from the first embodiment will be mainly described, and description of the same matters will be omitted. In FIG. 16, the same components as those according to the first embodiment are denoted by the same reference numerals.

As shown in FIG. 16, the laser interferometer 1D according to the present embodiment includes the movable sensor head unit 51 and the main body 59, and the optical modulator 12, the collimator 21 (the first collimator), and the collimator 22 (the second collimator) are provided in the sensor head unit 51. On the other hand, the laser light source 2, the photodetector 10, and the optical coupler 4 are provided in the main body 59.

According to such a configuration, since the collimators 21 and 22 are provided in the sensor head unit 51 and the optical coupler 4 is provided in the main body 59, the optical fibers 63 and 64 are routed between the sensor head unit 51 and the main body 59. The optical fiber 63 optically couples the collimator 21 and the optical coupler 4, and is a medium through which the reference light L2 propagates. The optical fiber 64 optically couples the collimator 22 and the optical coupler 4 and is a medium through which the object light L3 propagates. Since both the optical fibers 63 and 64 are routed to the outside, both the reference light L2 and the object light L3 are affected by a disturbance. Accordingly, an influence of a disturbance on the reference light L2 and an influence of a disturbance on the object light L3 are canceled out or prevented from each other. As a result, an S/N ratio of a light reception signal can be increased, and the S/N ratio can be stabilized.

In the present embodiment, it is possible to reduce optical elements provided in the sensor head unit 51 as compared with the first embodiment. As a result, it is possible to reduce the size of the sensor head unit 51.

In the third embodiment as described above, the same effects as those according to the first embodiment can also be attained.

### 4. Fourth Embodiment

Next, a laser interferometer according to a fourth embodiment will be described.

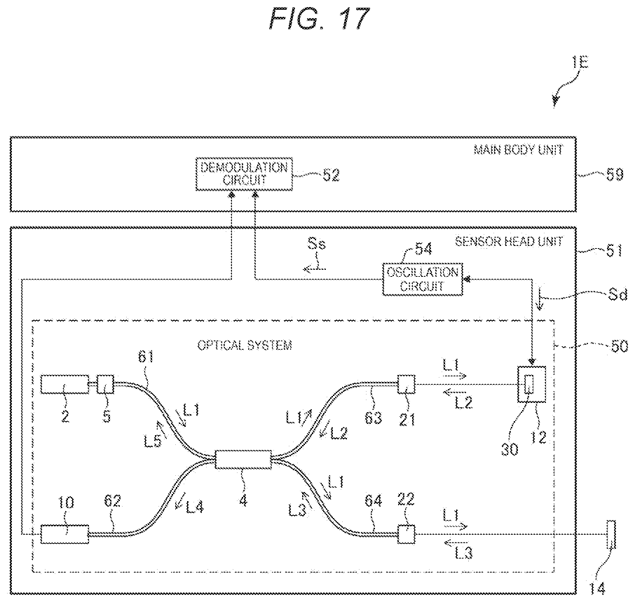

FIG. 17 is a schematic configuration diagram showing the sensor head unit 51 provided in a laser interferometer 1E according to the fourth embodiment.

Hereinafter, the fourth embodiment will be described. In the following description, differences from the first embodiment will be mainly described, and description of the same matters will be omitted. In FIG. 17, the same components as those according to the first embodiment are denoted by the same reference numerals.

The laser interferometer 1E according to the present embodiment is similar to the laser interferometer 1 according to the first embodiment except that an optical isolator 5 provided between the laser light source 2 and the optical coupler 4 is provided as shown in FIG. 17 in addition to the same configuration as the laser interferometer 1 according to the first embodiment described above. The optical isolator 5 has a function of reducing return light L5 traveling from the optical coupler 4 to the laser light source 2.

Here, the optical coupler 4 is a 2×2 coupler. Therefore, one light beam of the combined light L4 that is split by the optical coupler 4 is incident on the photodetector 10, and the other light beam of the combined light L4 that is split by the optical coupler 4 travels to the laser light source 2. Light traveling from the optical coupler 4 to the laser light source 2 is referred to as the “return light L5”. When the return light L5 is incident on the laser light source 2, laser oscillation in the laser light source 2 becomes unstable. Destabilization of the laser oscillation causes a decrease in an S/N ratio of a light reception signal.

Therefore, the laser interferometer 1E according to the present embodiment includes the optical isolator 5 as described above. The optical isolator 5 is provided between the laser light source 2 and the optical coupler 4, and reduces the return light L5 traveling from the optical coupler 4 to the laser light source 2.

According to such a configuration, it is possible to reduce a light intensity of the return light L5 incident on the laser light source 2. Accordingly, laser oscillation in the laser light source 2 can be stabilized. As a result, since a phase of the emitted light L1 is also stabilized, the S/N ratio of the light reception signal can be increased.

Examples of a principle of the optical isolator 5 include a polarization dependent type and a polarization independent type. Examples of a form of the optical isolator 5 include a free space type and a fiber direct coupling type.

Performance required for the optical isolator 5 can be expressed by, for example, an optical density (OD value) indicating capability of the optical isolator 5 for blocking the return light L5. The capability of the optical isolator 5 for blocking the return light L5 preferably satisfies OD 4. Accordingly, the laser oscillation can be sufficiently stabilized.

In the fourth embodiment as described above, the same effects as those according to the first embodiment can also be attained.

### 5. Fifth Embodiment

Next, a laser interferometer according to a fifth embodiment will be described.

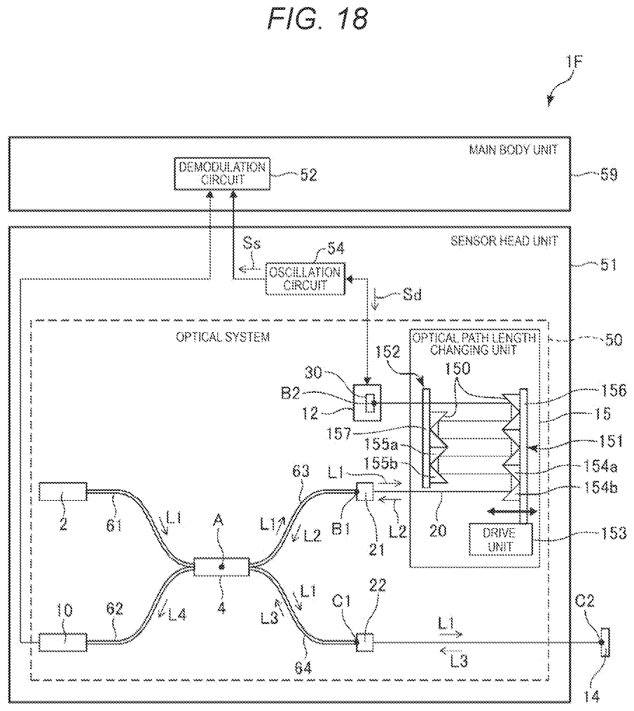

FIG. 18 is a schematic configuration diagram showing the sensor head unit 51 provided in a laser interferometer 1F according to the fifth embodiment.

Hereinafter, the fifth embodiment will be described. In the following description, differences from the first embodiment will be mainly described, and description of the same matters will be omitted. In FIG. 18, the same components as those according to the first embodiment are denoted by the same reference numerals.

The laser interferometer 1F according to the present embodiment is similar to the laser interferometer 1 according to the first embodiment except that the laser interferometer 1F includes an optical path length changing unit 15 as shown in FIG. 18 in addition to the same configuration as the laser interferometer 1 according to the first embodiment described above. The optical path length changing unit 15 has a function of changing an optical path length of an optical path through which the emitted light L1 emitted from the collimator 21 propagates.

Here, in order to increase the S/N ratio of the light reception signal, it is necessary to prevent a frequency fluctuation of the emitted light L1 emitted from the laser light source 2, that is, a phase fluctuation of the emitted light L1. However, since the frequency fluctuation of the emitted light L1 depends on a type of the laser light source 2, the frequency fluctuation cannot be easily prevented. Therefore, in the present embodiment, it is possible to prevent a decrease in the S/N ratio of the light reception signal due to the frequency fluctuation of the emitted light L1 by providing the optical path length changing unit 15, and thus it is possible to improve the measurement accuracy of a displacement of the object to be measured 14. Hereinafter, an operation of the optical path length changing unit 15 will be described.

The demodulation circuit 52 demodulates a sample signal that is derived from the object to be measured 14 from the light reception signal. Then, a displacement of the object to be measured 14 can be calculated based on the sample signal. When the measurement accuracy of the displacement is Δd, the measurement accuracy Δd is expressed according to the following formula (I).

$$Δ d = \frac{λΔϕ}{4 π n} + d ( \frac{Δ f}{f} + \frac{Δ n}{n} ) \qquad ( I )$$

λ: wavelength of emitted light L1
Δφ: phase of sample signal
n: refractive index of atmosphere
d: difference (optical path difference) between optical path length from point A to point B in FIG. 18 and optical path length from point A to point C2
Δf: frequency fluctuation (phase fluctuation) of emitted light L1
f: frequency of emitted light L1
Δn: refractive index fluctuation of atmosphere

The measurement accuracy Δd is expressed according to the above formula (I) including a first term including a wavelength λ, a second term including an optical path difference d and a frequency fluctuation Δf (a phase fluctuation) of the emitted light L1, and a third term including the optical path difference d and a refractive index fluctuation Δn of the atmosphere. In the above formula (I), when the optical path difference d is 0, the second term and the third term at the right side are also 0. In this case, the measurement accuracy Δd of a displacement is theoretically not affected by the frequency fluctuation Δf (the phase fluctuation) of the emitted light L1 or the refractive index fluctuation Δn of the atmosphere. On the other hand, when the optical path difference d is not 0, the frequency fluctuation Δf and the refractive index fluctuation Δn of the atmosphere affect the measurement accuracy Δd of a displacement. In particular, the frequency fluctuation Δf of the emitted light L1 may have a relatively large value depending on the type of the laser light source 2. In this case, the measurement accuracy Δd of a displacement of the object to be measured 14 may deteriorate depending on the type of the laser light source 2.

Therefore, in the present embodiment, the optical path length changing unit 15 is operated such that the optical path difference d is close to 0, that is, an optical path length from a point A to a point B2 and an optical path length from the point A to a point C2 in FIG. 18 is close to each other. The optical path length changing unit 15 has a function of changing an optical path length from the point A to the point B2. The measurement accuracy Δd of a displacement is less likely to be affected by the frequency fluctuation Δf [Hz] of the emitted light L1 by bringing the optical path difference d close to 0. As a result, a displacement of the object to be measured 14 can be accurately measured regardless of the type of the laser light source 2. A speed of the object to be measured 14 can also be calculated based on the displacement. The optical path length is an optical distance. In FIG. 18, the point A is the center of the optical coupler 4, a point B1 is a coupling point between the optical fiber 63 and the collimator 21, the point B2 is a light reflection point of the optical modulator 12, a point C1 is a coupling point between the optical fiber 64 and the collimator 22, and the point C2 is a light reflection point of the object to be measured 14.

The optical path length changing unit 15 shown in FIG. 18 includes a first reflective element 151, a second reflective element 152, and a drive unit 153 that drives the first reflective element 151. Each of the first reflective element 151 and the second reflective element 152 is an optical element that switches an optical path 20 along which the emitted light L1 travels. The drive unit 153 changes a physical distance between the first reflective element 151 and the second reflective element 152 by moving the first reflective element 151. Accordingly, an optical path length between the point A and the point B2 is changed.

The drive unit 153 generates a drive force and moves the first reflective element 151 in a direction of coupling the first reflective element 151 and the second reflective element 152. In addition, the drive unit 153 holds the first reflective element 151 at a target position. The drive unit 153 may not move the first reflective element 151 but move the second reflective element 152, or may move both the first reflective element 151 and the second reflective element 152. A moving direction is not limited as long as the optical path length of the optical path 20 can be changed.

The drive unit 153 may be a device that moves the first reflective element 151 along a straight line, and examples of the drive unit 153 include a linear stage, an electric actuator, and a piezo actuator.

The first reflective element 151 shown in FIG. 18 includes right angle prism mirrors 154a and 154b, and a base member 156 that supports the right angle prism mirrors 154a and 154b. Each of the right angle prism mirrors 154a and 154b is an optical element having a light reflection surface 150 intersecting with the optical path 20 at an angle of 450. The right angle prism mirrors 154a and 154b are arranged such that an angle formed by the light reflection surfaces 150 is 90°. Accordingly, the optical path 20 is folded back by a unit including a pair of the right angle prism mirrors 154a and 154b, and extends toward the second reflective element 152. The base member 156 collectively supports a plurality of pairs of the right angle prism mirrors 154a and 154b.

The second reflective element 152 shown in FIG. 18 includes right angle prism mirrors 155a and 155b, and a base member 157 that supports the right angle prism mirrors 155a and 155b. Each of the right angle prism mirrors 155a and 155b is an optical element having a light reflection surface 150 intersecting with the optical path 20 at an angle of 45°. The right angle prism mirrors 155a and 155b are arranged such that an angle formed by the light reflection surfaces 150 is 90°. Accordingly, the optical path 20 extending from the first reflective element 151 is folded back by a unit including a pair of the right angle prism mirrors 155a and 155b, and extends toward the first reflective element 151 again. The base member 157 collectively supports a plurality of pairs of the right angle prism mirrors 155a and 155b.

The right angle prism mirrors 154a, 154b, 155a, and 155b are highly accurate and easily available. Therefore, it is useful as optical elements for the first reflective element 151 and the second reflective element 152.

The configuration of the optical path length changing unit 15 is not limited to the above-described configuration as long as the optical path length of the optical path 20 can be changed. For example, the number of units, a structure of the right angle prism mirror, a path of the optical path 20, and the like may be different from those described above. In addition, a roof prism mirror or an integrated prism mirror may be used instead of the units described above.

As described above, the laser interferometer 1F according to the present embodiment further includes the optical path length changing unit 15. The optical path length changing unit 15 is provided between the collimator 21 (the first collimator) and the optical modulator 12, and changes an optical path length of the optical path 20 through which the emitted light L1 (the first laser light) emitted from the collimator 21 propagates.

According to such a configuration, the optical path length of the optical path 20 can be freely changed, and thus the optical path difference d in the above formula (I) can be brought close to 0, and it is preferable that the optical path difference d is 0. Accordingly, the measurement accuracy Δd of a displacement is less likely to be affected by the frequency fluctuation Δf of the emitted light L1. As a result, a displacement of the object to be measured 14 can be accurately measured regardless of the type of the laser light source 2.

Among the laser light sources 2 described above, a vertical cavity surface emitting laser diode (VCSEL) and a Fabry-Perot semiconductor laser diode (FP-LD) are inexpensive but the frequency fluctuation Δf of the emitted light L1 is relatively large. Therefore, the cost of the laser interferometer 1F can be reduced using the VCSEL or the FP-LD as the laser light source 2.

The optical path length of the optical path 20 shown in FIG. 18 is adjusted based on a physical distance between optical elements or a refractive index of the atmosphere. That is, when the optical path difference d is 0, the following Formula (II) is satisfied in the present embodiment.

n_{f}L_{fq}+n₀L_{q}=n_{f}L_{fs}+n₀Lₛ (II)

n_{f}: refractive index of core of optical fiber

n₀: refractive index of atmosphere

L_{fq}: propagation distance in optical fiber 63 in FIG. 18

L_{fs}: propagation distance in optical fiber 64 in FIG. 18

L_{q}: physical distance from point B1 to point B2 in FIG. 18

Lₛ: physical distance from point C1 to point C2 in FIG. 18

The optical path length of the optical path 20 is adjusted using a standard sample whose displacement or speed of vibration is known. Specifically, the displacement or the speed of the standard sample may be measured, and the drive unit 153 may be operated such that a measured value is close to a known value. When a measured value closest to the known value is obtained, the operation of the drive unit 153 may be stopped, and a measurement of the object to be measured 14 may be performed in this state.

As described above, the optical path length changing unit 15 shown in FIG. 18 includes the first reflective element 151 that is a movable optical element and the drive unit 153. The first reflective element 151 has a function of changing the optical path length of the optical path 20, that is, the optical path length of the optical path 20 through which the emitted light L1 (the first laser light) emitted from the collimator 21 (the first collimator) propagates, by moving the first reflective element 151.

According to the optical path length changing unit 15, a movement distance of the first reflective element 151 moved by the drive unit 153 and a change amount of the optical path length of the optical path 20 can be easily associated with each other. Therefore, it is possible to implement the optical path length changing unit 15 capable of easily adjusting the optical path length. In addition, an actuator that can be used as the drive unit 153 is easily available, and accuracy of adjusting a movement amount is high. Therefore, according to the optical path length changing unit 15 having such a configuration, it is possible to adjust the optical path length with high accuracy.

In the fifth embodiment as described above, the same effects as those according to the first embodiment can also be attained.

### 6. Sixth Embodiment

Next, a laser interferometer according to a sixth embodiment will be described.

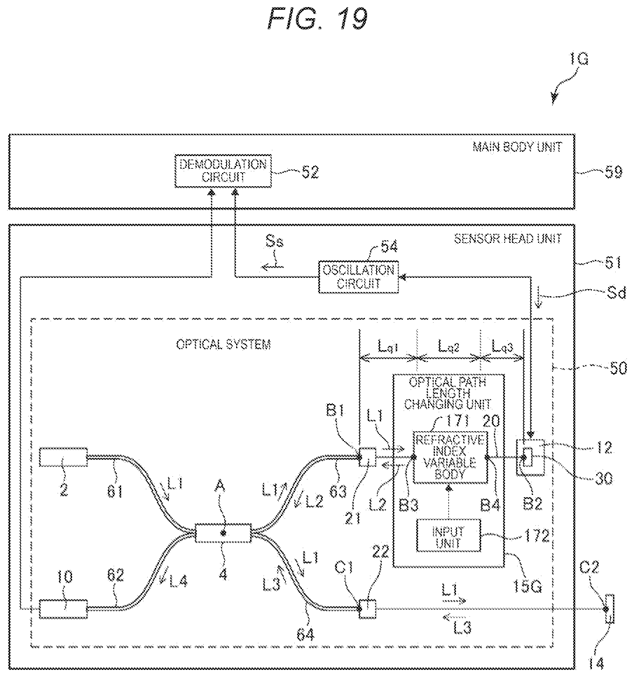

FIG. 19 is a schematic configuration diagram showing the sensor head unit 51 provided in a laser interferometer 1G according to the sixth embodiment.

Hereinafter, the sixth embodiment will be described. In the following description, differences from the fifth embodiment will be mainly described, and description of the same matters will be omitted. In FIG. 19, the same components as those according to the fifth embodiment are denoted by the same reference numerals.

As shown in FIG. 19, the laser interferometer 1G according to the present embodiment is the similar to the laser interferometer 1F according to the fifth embodiment except that a configuration of an optical path length changing unit 15G is different. The optical path length changing unit 15G has a function of changing an optical path length of an optical path through which the emitted light L1 emitted from the collimator 21 propagates.

In the laser interferometer 1F according to the fifth embodiment described above, the optical path length changing unit 15 includes the first reflective element 151 and the second reflective element 152. On the other hand, in the laser interferometer 1G according to the sixth embodiment, the optical path length changing unit 15G includes a refractive index variable body 171 and an input unit 172, as shown in FIG. 19. The refractive index variable body 171 is disposed at the optical path 20 along which the emitted light L1 travels and is a medium whose refractive index changes according to an input control signal. The input unit 172 inputs a control signal to the refractive index variable body 171.

In the optical path length changing unit 15G, the optical path 20 passes through the refractive index variable body 171. The optical path length of the optical path 20 can be changed by changing a refractive index of the refractive index variable body 171.

The refractive index variable body 171 is a light transmissive medium disposed on the optical path 20, and is, for example, a medium whose refractive index is changed using an electric filed, a magnetic field, heat, light, and the like as control parameters and inputting the control parameters as control signals. For example, a polymer dispersed liquid crystal is known as a medium using an electric field as a control parameter. The refractive index of the polymer dispersed liquid crystal changes depending on a magnitude of an applied electric field. It is possible to change the refractive index using an electric field that is easily controlled as a control parameter using a polymer dispersed liquid crystal as the refractive index variable body 171. Therefore, the configuration of the optical path length changing unit 15G can be further simplified.

An example of the refractive index variable body 171 other than the polymer dispersed liquid crystal is a medium whose refractive index is temperature dependent. Examples of such a medium include an inorganic material such as quartz glass and an organic material such as an acrylic resin. In this case, the input unit 172 is a temperature adjustment unit that inputs heat as a control parameter, and examples of the input unit 172 include a heat exchange element such as a Peltier element.

As described above, in the laser interferometer 1G according to the present embodiment, the optical path length changing unit 15G shown in FIG. 19 includes the refractive index variable body 171 and the input unit 172. The refractive index of the refractive index variable body 171 changes in response to an input of a control signal. The input unit 172 inputs a control signal to the refractive index variable body 171.

Since such an optical path length changing unit 15G does not include a movable portion, the optical path length changing unit 15G has high durability. Therefore, reliability of the laser interferometer 1G can be improved.

The optical path length of the optical path 20 shown in FIG. 19 is adjusted based on a physical distance between optical elements or a refractive index of the atmosphere. That is, when the optical path difference d is 0, the following formula (III) is satisfied in the present embodiment. In FIG. 19, a point B3 is an end of the refractive index variable body 171 at a point B1 side, and a point B4 is an end of the refractive index variable body 171 at a point B2 side.

n_{f}L_{fq}+n₀(L_{q1}+L_{q3})+nᵣL_{q2}=n_{f}L_{fs}+n₀Lₛ (III)

n_{f}: refractive index of core of optical fiber
n₀: refractive index of atmosphere
nᵣ: refractive index of refractive index variable body 171
L_{fq}: propagation distance in optical fiber 63 in FIG. 19
L_{fs}: propagation distance in optical fiber 64 in FIG. 19
L_{q1}: physical distance from point B1 to point B3 in FIG. 19
L_{q2}: physical length of refractive index variable body 171 (physical length from point B3 to point B4 in FIG. 19)
L_{q3}: physical distance from point B4 to point B2 in FIG. 19

The optical path length of the optical path 20 is adjusted using a standard sample whose displacement or speed of vibration is known. Specifically, the displacement or the speed of the standard sample may be measured, and the input unit 172 may be operated such that a measured value is close to a known value. When a measured value closest to the known value is obtained, the operation of the input unit 172 may be stopped, and a measurement of the object to be measured 14 may be performed in this state.

In the sixth embodiment as described above, the same effects as those according to the first embodiment can also be attained.

Although the laser interferometer according to an aspect of the present disclosure has been described above based on the embodiments, the laser interferometer according to an aspect of the present disclosure is not limited to the embodiments described above. A configuration of each part can be replaced with any configuration having the same function. Further, any other components may be added to the laser interferometer according to the embodiments described above.

Furthermore, the laser interferometer according to an aspect of the present disclosure may include any two or more of the embodiments described above and the modifications described above. For example, the fourth embodiment in which the optical isolator is provided and the fifth embodiment in which the movable optical element is provided may be combined (a first composite form), or the fourth embodiment and the sixth embodiment in which the refractive index variable body is provided may be combined (a second composite form). Further, the first composite form is based on the first embodiment, and may be based on the second embodiment or the third embodiment. Similarly, the second composite form is based on the first embodiment, and may be based on the second embodiment or the third embodiment.

The laser interferometer according to an aspect of the present disclosure can be applied to, for example, a vibration meter, an inclinometer, a distance meter (a length measuring device), and the like, in addition to the displacement meter or the speedometer described above. Examples of an application of the laser interferometer according to an aspect of the present disclosure include an optical fiber gyro that implements an optical comb interference measurement technique, an angular speed sensor, an acceleration sensor, an angular acceleration sensor, and the like that are capable of performing distance measurement, 3D imaging, spectroscopy, and the like.

Although a so-called Michelson interference optical system is provided in the embodiments and modifications described above, the laser interferometer according to an aspect of the present disclosure can also be applied to an interference optical system of another type such as a Mach-Zehnder interference optical system.

What is claimed is:

1. A laser interferometer comprising:
a laser light source configured to emit first laser light;
an optical modulator that includes a resonator and that is configured to modulate the first laser light using the resonator and to generate second laser light including a modulation signal;
a photodetector configured to receive the second laser light and third laser light including a sample signal generated by reflecting the first laser light from an object to be measured, and to output a light reception signal;
an optical coupler on which the first laser light, the second laser light, and the third laser light are incident and that splits the first laser light and splits combined light of the second laser light and the third laser light;
a first collimator configured to collimate one light beam of the first laser light split by the optical coupler and to emit the collimated light toward the optical modulator;
a second collimator configured to collimate the other light beam of the first laser light split by the optical coupler and to emit the collimated light toward the object to be measured;
a first optical wiring that optically couples the laser light source and the optical coupler and that is configured to cause the first laser light emitted from the laser light source to be incident on the optical coupler;
a second optical wiring that optically couples the photodetector and the optical coupler and that is configured to cause the combined light split by the optical coupler to be incident on the photodetector;
a third optical wiring that optically couples the first collimator and the optical coupler; and
a fourth optical wiring that optically couples the second collimator and the optical coupler.

2. The laser interferometer according to claim 1,
wherein
the optical coupler is an optical fiber type coupler, and
the first optical wiring, the second optical wiring, the third optical wiring, and the fourth optical wiring are optical fibers.

3. The laser interferometer according to claim 1, further comprising:
a movable sensor head unit; and
a main body, wherein
the laser light source, the optical modulator, the photodetector, the optical coupler, the first collimator, and the second collimator are provided in the sensor head unit.

4. The laser interferometer according to claim 3, further comprising:
a mounting substrate provided in the sensor head unit, wherein
the laser light source, the optical modulator, the photodetector, the optical coupler, the first collimator, and the second collimator are mounted on the mounting substrate.

5. The laser interferometer according to claim 1, further comprising:
a movable sensor head unit; and
a main body, wherein
the second collimator is provided in the sensor head unit, and
the laser light source, the optical modulator, the photodetector, the optical coupler, and the first collimator are provided in the main body.

6. The laser interferometer according to claim 1, further comprising:
a movable sensor head unit; and
a main body, wherein
the optical modulator, the first collimator, and the second collimator are provided in the sensor head unit, and
the laser light source, the photodetector, and the optical coupler are provided in the main body.

7. The laser interferometer according to claim 1, further comprising:
an optical isolator that is provided between the laser light source and the optical coupler and that is configured to reduce return light traveling from the optical coupler toward the laser light source.

8. The laser interferometer according to claim 1, further comprising:
a third collimator that is provided between the laser light source and the optical coupler and that is configured to collimate the first laser light.

9. The laser interferometer according to claim 1, further comprising:
an optical path length changing unit that is provided between the first collimator and the optical modulator and that is configured to change an optical path length of an optical path along which the first laser light emitted from the first collimator propagates.

10. The laser interferometer according to claim 9, wherein
the optical path length changing unit includes
a movable optical element configured to change the optical path length when the movable optical element moves; and
a drive unit configured to drive the movable optical element.

11. The laser interferometer according to claim 9, wherein
the optical path length changing unit includes
a refractive index variable body whose refractive index changes in response to an input of a control signal, and
an input unit configured to input the control signal to the refractive index variable body.

12. The laser interferometer according to claim 1, further comprising:
a demodulation circuit configured to demodulate the sample signal from the light reception signal based on a reference signal; and
an oscillation circuit configured to operate using the resonator as a signal source and to output the reference signal.

13. The laser interferometer according to claim 2, further comprising:
a demodulation circuit configured to demodulate the sample signal from the light reception signal based on a reference signal; and
an oscillation circuit configured to operate using the resonator as a signal source and to output the reference signal.

14. The laser interferometer according to claim 3, further comprising:
a demodulation circuit configured to demodulate the sample signal from the light reception signal based on a reference signal; and
an oscillation circuit configured to operate using the resonator as a signal source and to output the reference signal.

15. The laser interferometer according to claim 4, further comprising:
a demodulation circuit configured to demodulate the sample signal from the light reception signal based on a reference signal; and
an oscillation circuit configured to operate using the resonator as a signal source and to output the reference signal.

16. The laser interferometer according to claim 5, further comprising:
a demodulation circuit configured to demodulate the sample signal from the light reception signal based on a reference signal; and
an oscillation circuit configured to operate using the resonator as a signal source and to output the reference signal.

17. The laser interferometer according to claim 6, further comprising:
a demodulation circuit configured to demodulate the sample signal from the light reception signal based on a reference signal; and
an oscillation circuit configured to operate using the resonator as a signal source and to output the reference signal.

18. The laser interferometer according to claim 7, further comprising:
a demodulation circuit configured to demodulate the sample signal from the light reception signal based on a reference signal; and
an oscillation circuit configured to operate using the resonator as a signal source and to output the reference signal.

19. The laser interferometer according to claim 8, further comprising:
a demodulation circuit configured to demodulate the sample signal from the light reception signal based on a reference signal; and
an oscillation circuit configured to operate using the resonator as a signal source and to output the reference signal.

20. The laser interferometer according to claim 9, further comprising:
a demodulation circuit configured to demodulate the sample signal from the light reception signal based on a reference signal; and
an oscillation circuit configured to operate using the resonator as a signal source and to output the reference signal.
